(19) United States
(12) Patent Application Publication
(10) Pub. No.: US 2015/0324747 A1
(43) Pub. Date: Nov. 12, 2015

(54) TALENT ACQUISITION PORTAL, SYSTEM, AND METHOD

(71) Applicants: Kristopher Corso, Encinitas, CA (US); Kathleen West-Evans, Bothell, WA (US); James Miller, Encinitas, CA (US)

(72) Inventors: Kristopher Corso, Encinitas, CA (US); Kathleen West-Evans, Bothell, WA (US); James Miller, Encinitas, CA (US)

(73) Assignee: CSAVR/THENET-DISABLEDPERSON, INC. PARTNERSHIP, Encinitas, CA (US)

(21) Appl. No.: 14/272,704

(22) Filed: May 8, 2014

(51) Int. Cl. G06Q 10/10

(52) U.S. Cl. CPC G06Q 10/1053

(57) ABSTRACT

A talent acquisition portal, system, and method includes one or more servers collectively configured to implement: an employer function enabling the one or more employers to post opportunities and find candidates based on a two-tiered search structure; a counselor function enabling the one or more counselors to invite other counselors to join the talent acquisition portal, interact with assigned candidates of the one or more candidates, and assist the assigned candidates with finding an opportunity; a candidate function enabling the one or more candidates to sign up responsive to an invite from one of the one or more counselors, develop a resume, and search and apply for one of the opportunities; and a triangulated communication structure between the one or more employers, the one or more counselors, and/or the one or more candidates.

### FIELD OF THE DISCLOSURE

The present disclosure relates generally to computer networking systems and methods. More particularly, the present disclosure relates to a talent acquisition portal, system, and method.

### BACKGROUND OF THE DISCLOSURE

With the prevalence of the Internet, employment websites have flourished. Generally, employment websites allow employers to post jobs and prospective employees to search and apply for the posted jobs. Other aspects can include employer reviews, career and job search advice, etc. Conventional employment websites work with this one-to-one model, i.e., employer to prospective employee. While this one-to-one model works well across a broad spectrum of industries for prospective employees, there are circumstances where this is inadequate. For example, this one-to-one model is inadequate in the context of vocational rehabilitation. Vocational rehabilitation is a process which enables persons with functional, psychological, developmental, cognitive and emotional impairments, sensory, mobility or health conditions to overcome barriers to accessing, maintaining or returning to employment or other useful occupation. In the U.S., vocational rehabilitation is operated by various personnel at governmental agencies working with prospective employees who qualify for such services. Vocational rehabilitation can require input from a range of health care professionals and other non-medical disciplines such as disability employment advisers and career counsellors. Techniques used can include: assessment, appraisal, program evaluation and research; goal setting and intervention planning; provision of health advice and promotion, in support of returning to work; support for self-management of health conditions; making adjustments to the medical and psychological impact of a disability; case management, referral, and service coordination; psychosocial interventions; career counseling, job analysis, job development, and placement services; and functional and work capacity evaluations.

Conventionally/Historically, the various state governmental agencies have operated as independent silos from one another, i.e., there is little coordination there between. Through the membership organization (CSAVR) VR has built a national infrastructure of staff serving business/employers, the National Employment Team (NET). But VR needed a tool to more efficiently and effectively centralize and connect the VR candidates to employment opportunities across the country. Additionally, new regulations have emerged from the Federal Government requiring contractors to employ at least 7% of its workforce as employees qualified for vocational rehabilitation, and at least 8% of its workforce as employees characterized as protected veterans. There is simply no adequate conventional system or method that enable employers, governmental personnel, and prospective employees to work together, across various governmental agencies, geographies, etc. in assisting vocational rehabilitation job placement. The one-to-one model practiced by conventional employment websites does not adequately map into the processes required herewith.

### BRIEF SUMMARY OF THE DISCLOSURE

In an exemplary embodiment, a talent acquisition portal includes one or more servers communicatively coupled over a network to one or more employers, one or more counselors, and one or more candidates, wherein the one or more servers are collectively configured to implement: an employer function enabling the one or more employers to post opportunities and find candidates based on a two-tiered search structure; a counselor function enabling the one or more counselors to invite other counselors to join the talent acquisition portal, interact with assigned candidates of the one or more candidates, and assist the assigned candidates with finding an opportunity; a candidate function enabling the one or more candidates to sign up responsive to an invite from one of the one or more counselors, develop a resume, and search and apply for one of the opportunities; and a triangulated communication structure between the one or more employers, the one or more counselors, and/or the one or more candidates.

In another exemplary embodiment, a talent acquisition system includes a network interface, a data store, and a processor, each communicatively coupled therebetween; and memory storing instructions that, when executed, cause the processor to: sign up a user as one of an employer, a counselor, and a candidate, wherein the counselor is signed up responsive to an invite from another counselor, and wherein the candidate is signed up response to an invite from a counselor; receive opportunities to post from the employer; perform a two-tiered search for the employer; invite other counselors by the counselor; enable the counselor to interact with assigned candidates; enable the counselor to assist the assigned candidates with finding an opportunity; enable the candidate to develop a resume and search and apply for the opportunities; and coordinate a triangulated communication structure between the employer, the counselor, and/or the candidate.

In yet another exemplary embodiment, a talent acquisition method includes signing up a user as one of an employer, a counselor, and a candidate, wherein the counselor is signed up responsive to an invite from another counselor, and wherein the candidate is signed up response to an invite from a counselor; receiving opportunities to post from the employer; performing a two-tiered search for the employer; inviting other counselors by the counselor; enabling the counselor to interact with assigned candidates; enabling the counselor to assist the assigned candidates with finding an opportunity; enabling the candidate to develop a resume and search and apply for the opportunities; and coordinating a triangulated communication structure between the employer, the counselor, and/or the candidate.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a network diagram of a system for a talent acquisition portal, system, and method;

FIG. 2 is a block diagram of a server which may be used in the system of FIG. 1 or standalone;

FIG. 3 is a block diagram of a mobile device which may be used in the system of FIG. 1 or with any other system;

FIG. 4 is a flowchart of an employer method for functionality associated with the TAP in FIG. 1;

FIGS. 5-19 are associated screen shots of the TAP in FIG. 1 and the employer method of FIG. 4;

FIG. 20 is a flowchart of a counselor method for functionality associated with the TAP in FIG. 1;

FIGS. 21-25 are associated screen shots of the TAP in FIG. 1 and the counselor method of FIG. 20;

FIG. 26 is a flowchart of a candidate method for functionality associated with the TAP in FIG. 1; and

FIGS. 27-29 are associated screen shots of the TAP in FIG. 1 and the candidate method of FIG. 26.

### DETAILED DESCRIPTION OF THE DISCLOSURE

In various exemplary embodiments, the present disclosure relates to a talent acquisition portal (TAP), system, and method. The talent acquisition portal, system, and method include an online system with a centralized talent pool of Vocational Rehabilitation (VR) candidates looking for employment, with a job posting system for businesses looking to hire individuals with disabilities. The talent acquisition portal, system, and method offers business the opportunity to post jobs, search candidate resumes based on skill sets and geographic availability, capture job metrics, generate compliance reports, interview candidates, have online job fairs, and have their jobs seen by individuals with disabilities across the country. Business also benefit from Vocational Rehabilitation Counselors and Candidates both searching for jobs.

The TAP, system, and method offers various unique advantages over conventional employee websites including, without limitation: 1) triangulated email between counselor, candidate, and employer; 2) a mechanism for counselors doing searches for candidates and recommending and starring jobs for them; 3) all the Office of Federal Contract Compliance Programs (OFCCP) Compliance metrics, these include tracking the applications and hires; 4) automatic tracking when a candidate is hired to begin a 90 days verification process; 5) a two-tiered searching structure for employers to provide initial matching of location and category so there is no discrimination; 5) unified counselor tracking of candidates in dashboard; 6) a centralized repository of candidates across geographic regions qualifying with disabilities; and the like. The TAP is a closed online system that is available to any employer, to VR counselors, and to candidates who qualify as individuals with disabilities.

The TAP offers business the opportunity to post jobs, search candidate resumes based on skill sets and geographic availability, capture job metrics, generate compliance reports, interview candidates, have online job fairs, and have their jobs seen by individuals with disabilities across the country. Business will also benefit from VR Counselors and qualified candidates searching the available opportunities. Small, medium, and large businesses all have the opportunity to receive all the benefits TAP offers through flexible job posting packages, and outreach opportunities. TAP is supported by VR Business Consultants in every state, the territories and D.C. who can partner and can provide support services to businesses at the national, state and local level.

Vocational Rehabilitation serves approximately 1 million individuals with disabilities per year, and has over 25,000 staff across 80 agencies in all 50 states, D.C. and U.S. territories. VR offers the largest talent pool of candidates with disabilities in the United States, making the TAP a premier web portal for business to hire individuals with disabilities. The TAP offers businesses and employer customers the opportunity to post jobs that will be seen in all 80 VR Agencies and 25,000 staff in the 50 States, Territories and DC, the TAP uses a state of the art “TAP Matching” system linking jobs to candidates; and the TAP utilizes application programming interfaces (APIs) which can integrate into other software. The TAP further includes a rich suite of reporting and metrics for generating reports such as for the number of jobs posted, number of job views, number and visibility of applications/applicants, and tracking hires. The metrics were built with input from the National Industrial Liaison Group (NILG), The United States Business Leadership Network (USBLN) and the Office of Federal Contracts and Compliance (OFCCP).

With the TAP, employers have access to the largest centralized talent pool of individuals with disabilities in the country and can view resumes of a talent pool of Candidates who have self-identified as applicants with disabilities and access candidates who have inputted skill set, experience and geographic availability. Again, Vocational Rehabilitation serves close to one million individuals with disabilities annually with approximately 250,000 job ready candidates at any given time. Additional benefits include online Virtual Career Events and Interviews; downloadable PDF's that transcript conversations; matching that matches employers to candidates who are available to relocate for a job; access to point of contacts at the national, state or local level to assist you in developing a strategic plan; etc. The TAP is adapted to server all sizes of employers from a single interface and enables development of effective partnerships between businesses, qualified VR staff and specially trained employer consultants. The TAP is an effective and concise in allowing businesses to become an employer of choice for talented candidates with disabilities.

For candidates, Vocational Rehabilitation's candidates with disabilities can explore job opportunities at the local, state or national level by utilizing TAP's “TAP Matching” which will match their skills to specific jobs and locations. Candidates can interface with companies who have a commitment to hiring qualified applicants with disabilities. These candidates do this with the support of their VR Counselor and the National Employment Team (NET). The site is fully accessible.

Further, the TAP is built with the input of senior officials at the Office of Federal Contracts and Compliance (OFCCP) so TAP features all the necessary metrics for the new 503 and VEVRAA regulations. Employers will be more than impressed by the reporting metrics of TAP and the ease of generating reports.

### Talent Acquisition Portal (TAP) System

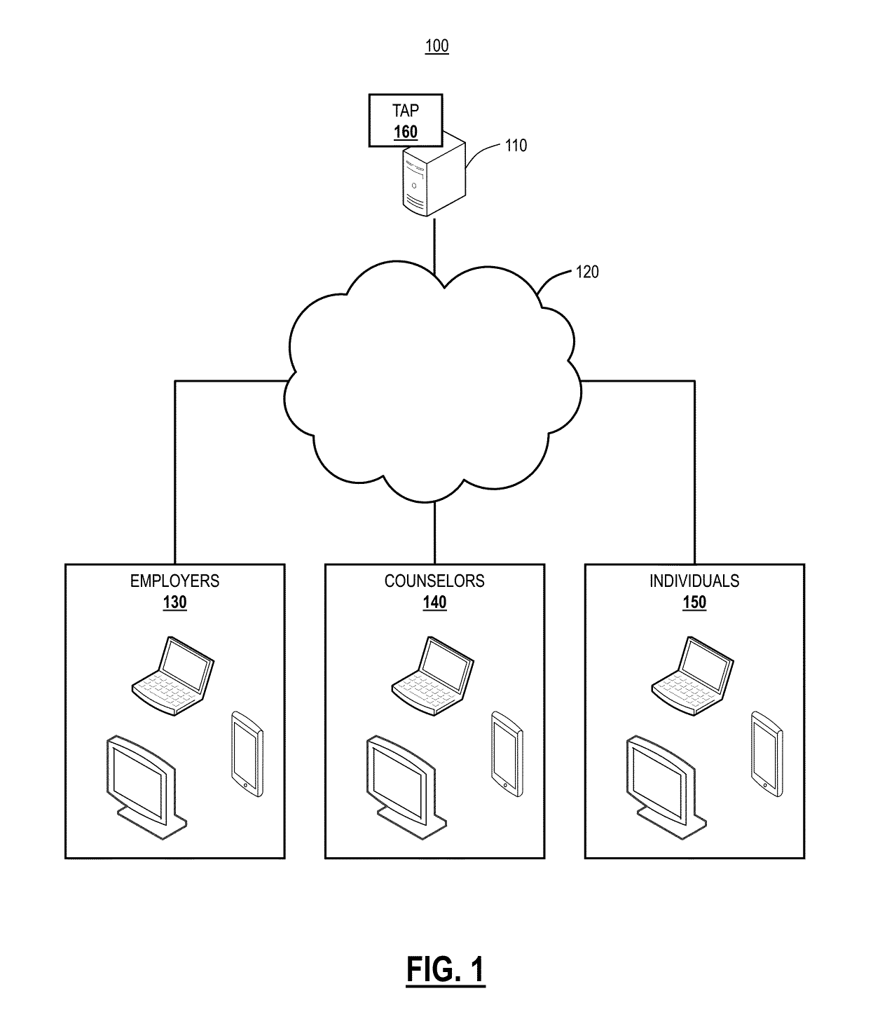

Referring to FIG. 1, in an exemplary embodiment, a network diagram illustrates a system 100 for a talent acquisition portal, system, and method. The system 100 includes a server 110 communicatively coupled to a network 120 such as the Internet, a wide area network (WAN), or the like. The system 100 further includes various users which can be categorized as employers 130, counselors 140, and individuals 150 that each can access the server 110 via the network 120. Specifically, the users 130, 140, 150 can access the server 110 via various types of computing devices including, without limitation, laptop computers, desktop computers, net-books, tablets, smart phones, etc. Variously herein, the talent acquisition portal, system, and method are described with reference to FIG. 1 using the Vocational Rehabilitation example. Here, the employers 130 are businesses, etc. with jobs needing to be filled and with a desire to fill these jobs with the individuals 150 who qualify for job placement assistance such as through Vocational Rehabilitation. The counselors 140 can be governmental agency employees, for example, and each are assigned to assist a subset of the individuals 150 in job placement. As described herein, the counselors 140 are any individuals who work for an agency, organization, etc. that provide job placement assistance to the individuals 150 based on their situation, i.e., the individuals 150 qualify for the job placement assistance such as due to a disability, status as a veteran, etc. As such, the talent acquisition portal, system, and method is not a one-to-one system like the conventional employment websites described above.

The server 110 is configured to host a talent acquisition portal (TAP) 160 on which the employers 130, the counselors 140, and the individuals 150 interact. Note, while the server 110 is illustrated as a single device, those of ordinary skill in the art will recognize the TAP 160 can be hosted on a plurality of servers 110 in the cloud. The TAP 160 is generally software executed on the server 110 for providing various functionality as described herein. The TAP 160 can present the users 130, 140, 150 a graphical user interface such as via Hypertext Transfer Protocol (HTTP) or HTTP secure (HTTPS) over the network 120. Also, the TAP 160 contemplates other methods of operation such as via an application (“app”) on a computing device of a user 130, 140, 150. There can also be multiple methods of interacting with the TAP 160, e.g., Web-based, app-based, etc. The functionality and user interface is different between the different categories of the users 130, 140, 150 as is further described herein.

### Exemplary Server for TAP System

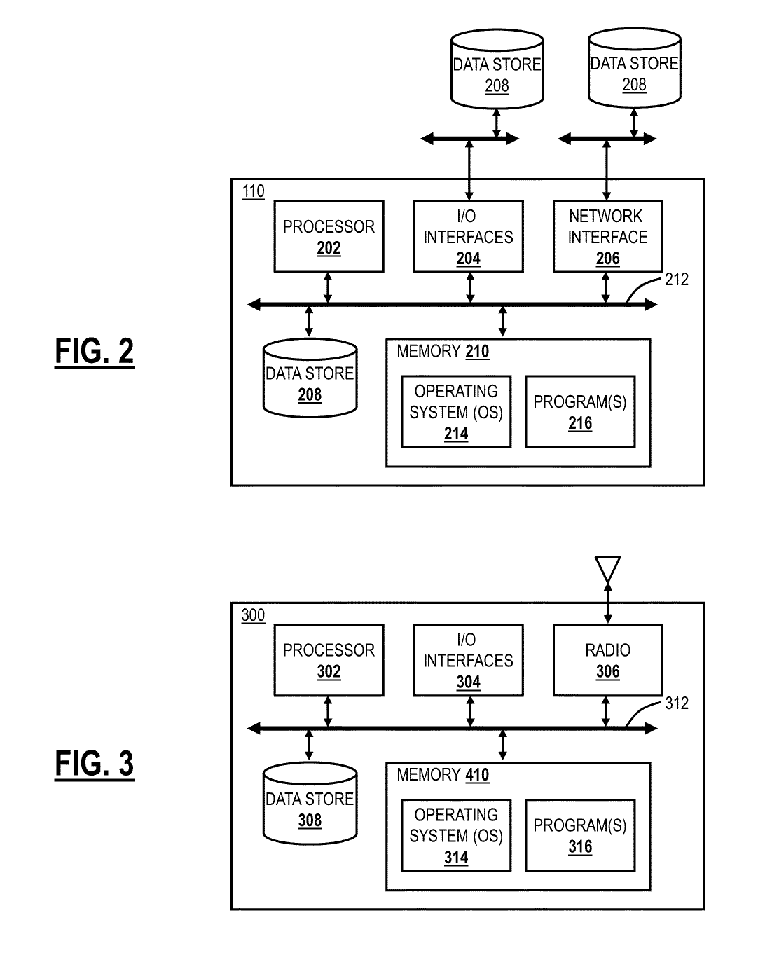

Referring to FIG. 2, in an exemplary embodiment, a block diagram illustrates a server 110 which may be used in the system 100, in other systems, or standalone. The server 110 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 110 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a central processing unit (CPU), an auxiliary processor among several processors associated with the server 110, a semiconductor-based microprocessor (in the form of a microchip or chip set), or generally any device for executing software instructions. When the server 110 is in operation, the processor 202 is configured to execute software stored within the memory 210, to communicate data to and from the memory 210, and to generally control operations of the server 110 pursuant to the software instructions. The I/O interfaces 204 may be used to receive user input from and/or for providing system output to one or more devices or components. User input may be provided via, for example, a keyboard, touch pad, and/or a mouse. System output may be provided via a display device and a printer (not shown). I/O interfaces 204 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 206 may be used to enable the server 110 to communicate on a network, such as the Internet, a wide area network (WAN), a local area network (LAN), and the like, etc. The network interface 206 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 206 may include address, control, and/or data connections to enable appropriate communications on the network. A data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 110 such as, for example, an internal hard drive connected to the local interface 212 in the server 110. Additionally in another embodiment, the data store 208 may be located external to the server 110 such as, for example, an external hard drive connected to the I/O interfaces 204 (e.g., SCSI or USB connection). In a further embodiment, the data store 208 may be connected to the server 110 through a network, such as, for example, a network attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another, but can be accessed by the processor 202. The software in memory 210 may include one or more software programs, each of which includes an ordered listing of executable instructions for implementing logical functions. The software in the memory 210 includes a suitable operating system (0/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Specifically, the TAP 160 can be implemented by the one or more programs 216.

### Exemplary Device for Accessing the TAP System

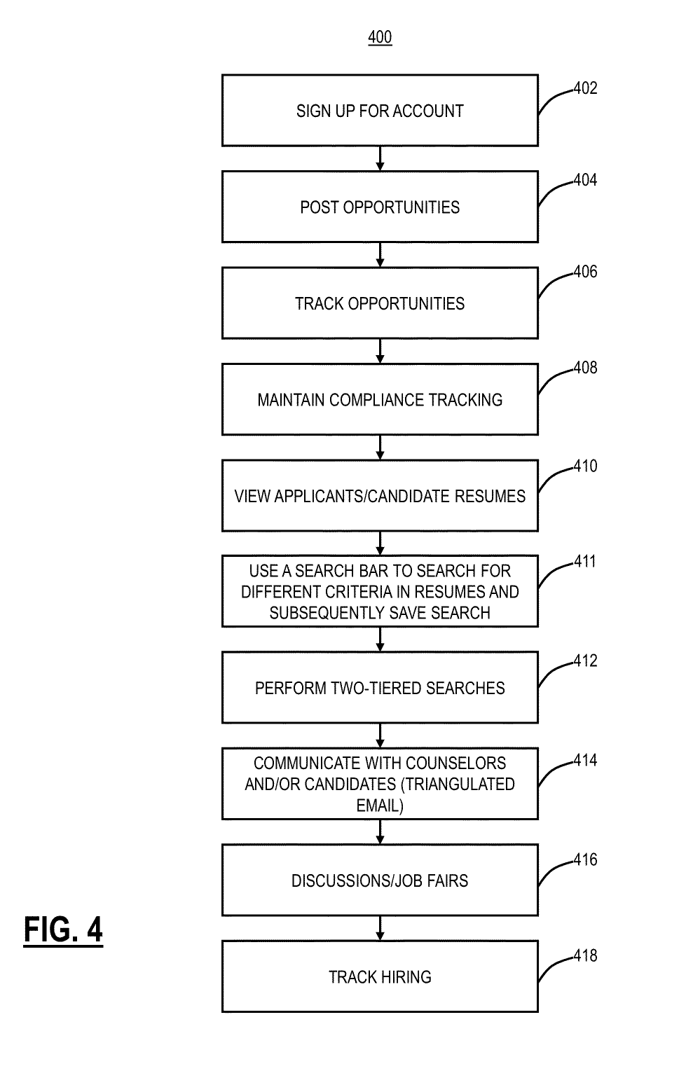

Referring to FIG. 3, in an exemplary embodiment, a block diagram illustrates a mobile device 300, which may be used in the system 100 or the like. The mobile device 300 can be a digital device that, in terms of hardware architecture, generally includes a processor 302, input/output (I/O) interfaces 304, a radio 306, a data store 308, and memory 310. It should be appreciated by those of ordinary skill in the art that FIG. 4 depicts the memory 310 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a central processing unit (CPU), an auxiliary processor among several processors associated with the memory 310, a semiconductor-based microprocessor (in the form of a microchip or chip set), or generally any device for executing software instructions. When the mobile device 300 is in operation, the processor 302 is configured to execute software stored within the memory 310, to communicate data to and from the memory 310, and to generally control operations of the mobile device 300 pursuant to the software instructions. In an exemplary embodiment, the processor 302 may include a mobile optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, bar code scanner, and the like. System output can be provided via a display device such as a liquid crystal display (LCD), touch screen, and the like. The I/O interfaces 304 can also include, for example, a serial port, a parallel port, a small computer system interface (SCSI), an infrared (IR) interface, a radio frequency (RF) interface, a universal serial bus (USB) interface, and the like. The I/O interfaces 304 can include a graphical user interface (GUI) that enables a user to interact with the memory 310. Additionally, the I/O interfaces 304 may further include an imaging device, i.e. camera, video camera, etc.

The radio 306 enables wireless communication to an external access device or network. Any number of suitable wireless data communication protocols, techniques, or methodologies can be supported by the radio 306, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; proprietary wireless data communication protocols such as variants of Wireless USB; and any other protocols for wireless communication. The data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system (O/S) 314 and programs 316. The operating system 314 essentially controls the execution of other computer programs, and provides scheduling, input-output control, file and data management, memory management, and communication control and related services. The programs 316 may include various applications, add-ons, etc. configured to provide end user functionality with the mobile device 300. For example, exemplary programs 316 may include, but not limited to, a web browser, social networking applications, streaming media applications, games, mapping and location applications, electronic mail applications, financial applications, and the like. In a typical example, the end user typically uses one or more of the programs 316 along with a network.

### Employer Functionality in the TAP

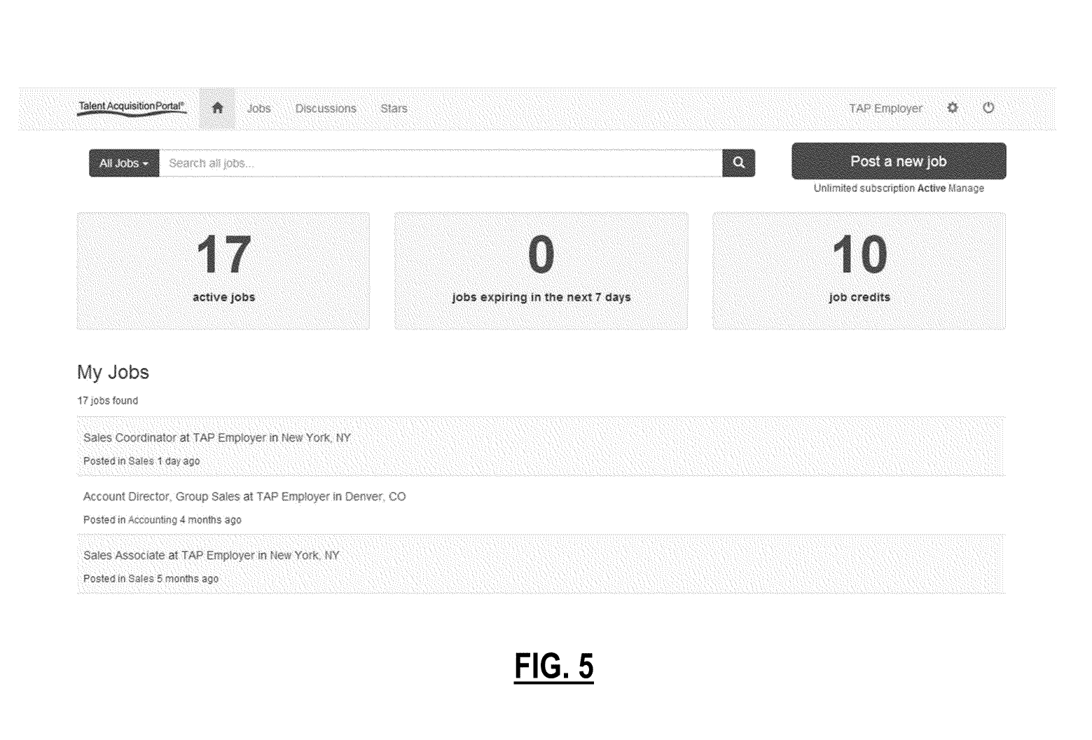

Referring to FIGS. 4-19, in an exemplary embodiment, a flowchart (FIG. 4) illustrates an employer method 400 for functionality associated with the TAP 160 and associated screen shots (FIGS. 5-19) illustrate interaction by the employer 130 with the TAP 160 through the employer method 400. The employer method 400 contemplates operation by the employers 130 on the TAP 160 in the system 100. While the various steps illustrated in the employer method 400 are illustrated in sequence, the steps contemplate any sequence, or omission of some of the steps. The employer method 400 includes the employer 130 signing up for an account with the TAP 160 (step 402). The employer 130 can sign up with the TAP 160 to access, in a unified fashion, various candidates who qualify for vocational rehabilitation. The TAP 160 is an online system which includes both a national talent pool of Vocational Rehabilitation (VR) candidates looking for employment and a job posting system for employer 130 looking to hire the individuals with disabilities. During the sign up step 402, the employer 130 can subscribe to the TAP 160 such as per job, for a set number of credits, per time period, etc. Once signed up, the employer 130 can access the TAP 160 through a user ID/password, biometric authorization, etc.

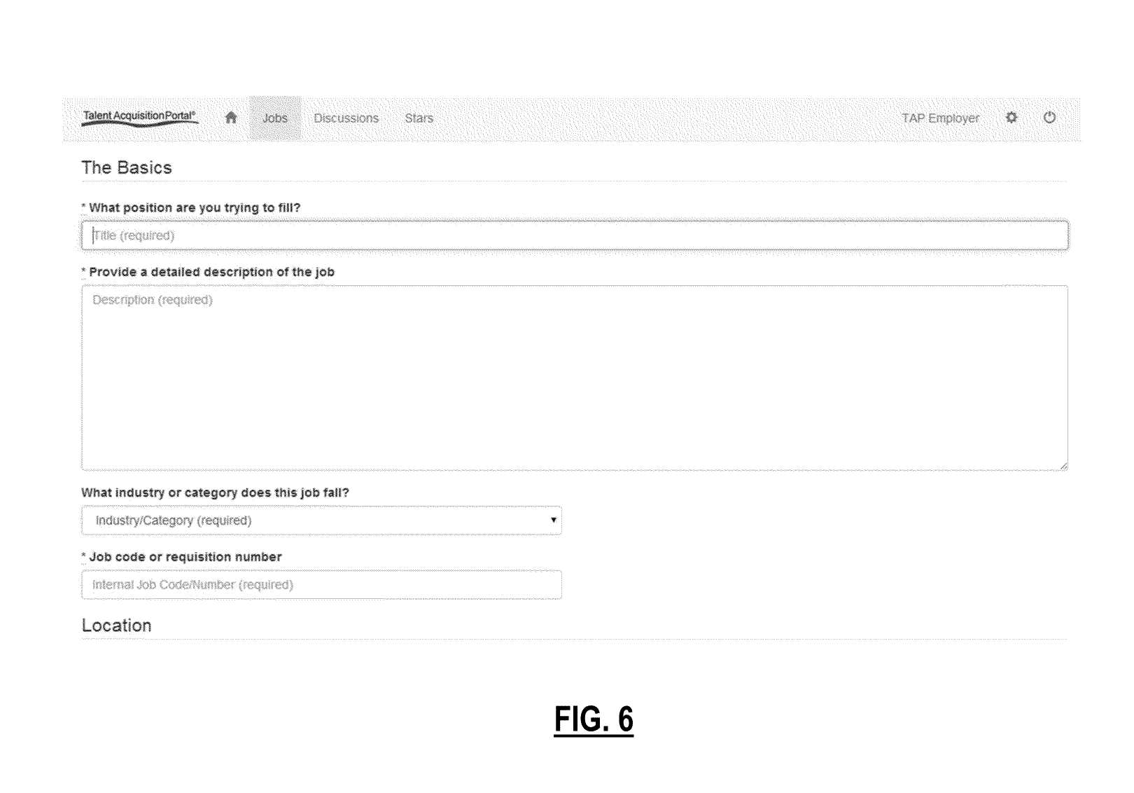

FIG. 5 illustrates an exemplary home screen for the employer 130 following sign-in. The employer home page lists active jobs the employer 130 has, jobs that will be expiring within the next 7 days, and job credits available to them to post jobs. In an exemplary embodiment, jobs can only be posted with credits. For example, packages of a set number of jobs are available, as well as unlimited monthly or unlimited subscriptions. Next, the employer method 400 includes the employer 130 posting opportunities (step 404). Based on the need of the employer 130, posting a job can be done manually, or automated through an API. Job scraping is available, and jobs can be automatically taken from a career page if necessary to the TAP 160. FIG. 6 is a screen shot of an exemplary job post by the employer 130. Here, in FIG. 6, the employer 130 can manually add a job through a fill-in form processes which takes information related to the job, i.e., position, description, industry or category, job code or requisition number, location, etc.

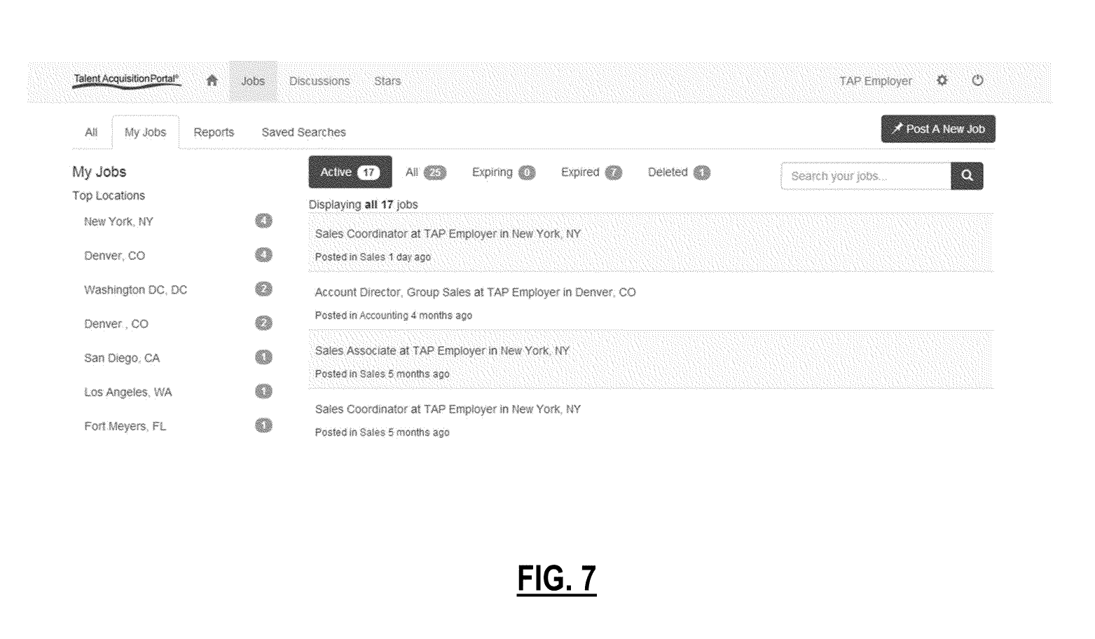

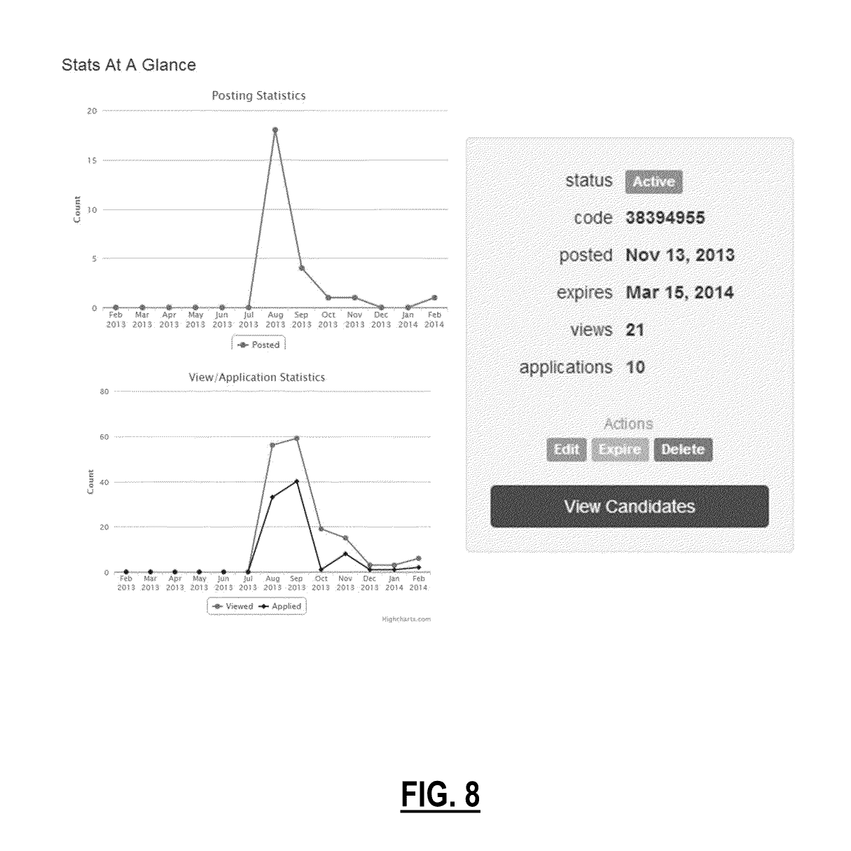

Next, the employer method 400 includes the employer 130 tracking opportunities (i.e., jobs) (step 406). The employer jobs are divided into “Active”, “All”, “Expiring”, “Expired”, and “Deleted” sections. The employer 130 can always have access to any jobs they have posted within the system and metrics for those jobs will always readily be available. FIG. 7 is a screen shot of job tracking for the employer 130. Note, the job tracking can track jobs by location and/or by status (active, all, expiring, expired, deleted). The job tracking can also include detailed job metrics which can include information about a job that was posted, when it expires, how many times it was viewed, and how many candidates (individuals with disabilities) applied for the job posted. Graphs and analytics are also provided that help an employer capture appropriate metrics for compliance based on the total number of jobs, applies, and views in the system. Reports can also be generated with this information, such as illustrated in FIG. 8, for example.

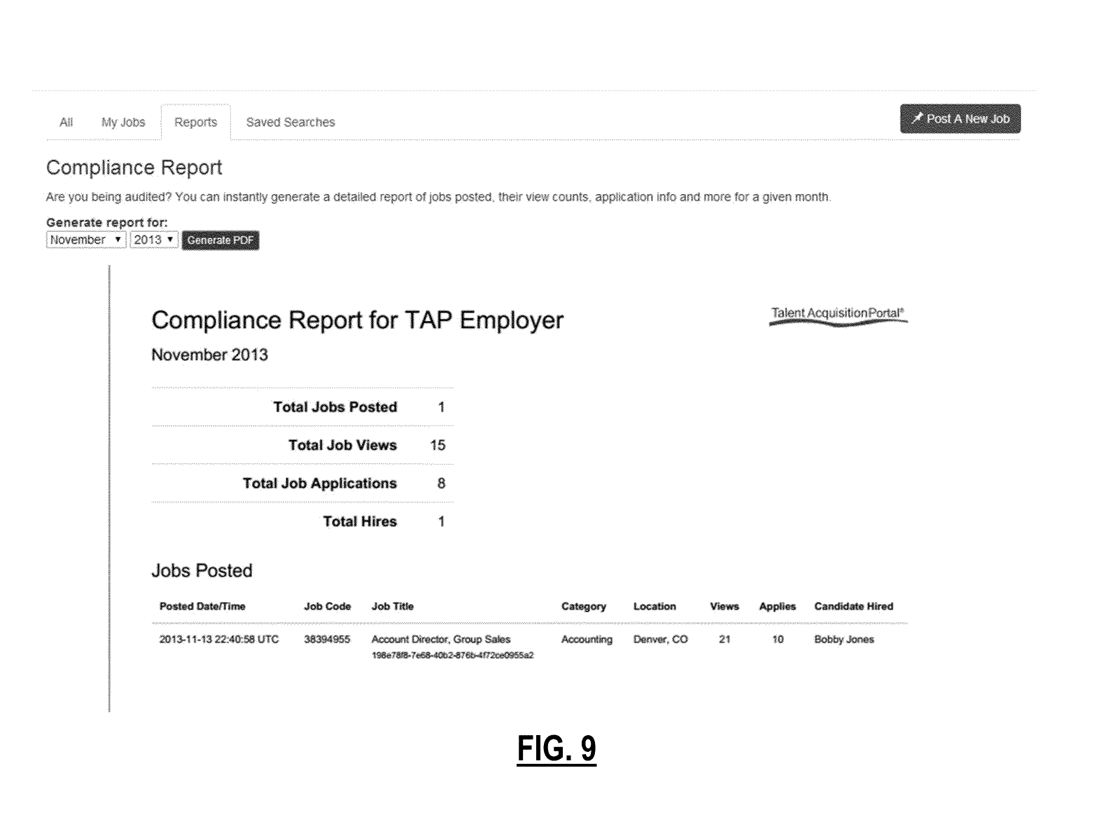

The employer method 400 allows the employer 130 to maintain compliance tracking (step 408). Compliance reports can be generated at any time by a business or organization who is using the TAP 160. The compliance report can be generated by month and year. A compliance report can include the employer's name, month/year of the report, total jobs posted in the month, total job views in the month, total applications in the month, and total hires in the month. Below the stats, there will be a section that includes the information about a job posted that resulted in a hire. FIG. 9 is a screen shot of an exemplary compliance report for the employer 130. The compliance report can be generated for a specified time period, can show the jobs posted, total views, total applicants, and the hired candidate.

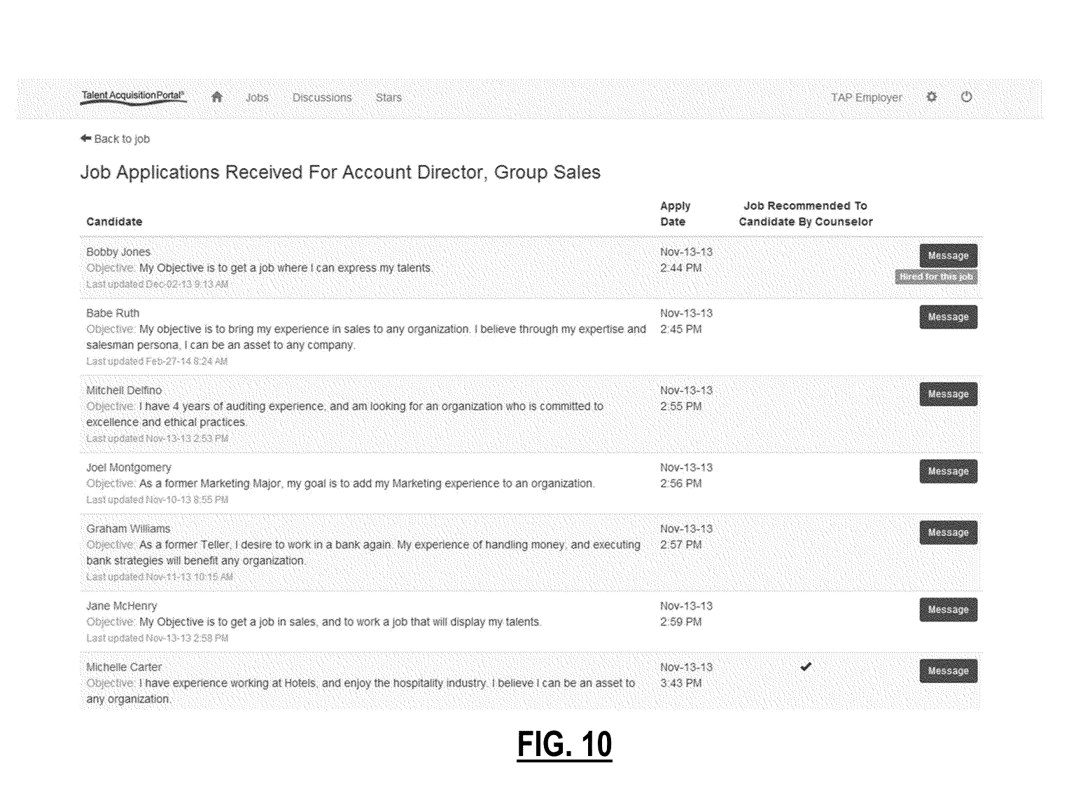

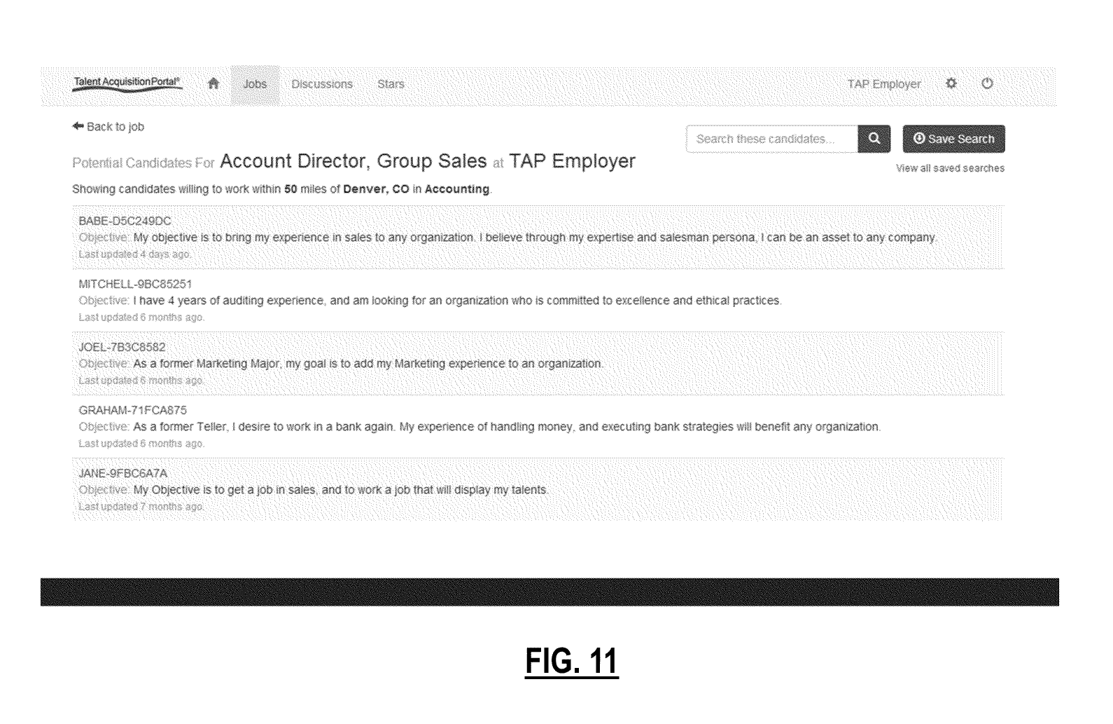

The employer method 400 allows the employer 130 to view applicants and/or candidate's resumes (step 410). Specifically, the employer can view specific applicants who apply to a posted job as well as view candidates for a possible job. By clicking a linked number next to “Applications” which is located in the individual job metrics, the employer 130 can gain access to a list of who has applied for their jobs in the TAP 160. Note, the TAP 160 can partially display a candidate's name to obscure the identity of the candidate until the candidate becomes an applicant. At this point, since a candidate has applied, the employer 130 can see the candidate's full name. This is done so that an employer can match the candidate up to an application received in their Applicant Tracking System (ATS). For example, FIG. 10 illustrates an exemplary screen shot of job applicants for a position in the TAP 160.

When the employer 130 posts a job, they can designate where the candidate will go when they select “Apply for Job”. The employer 130 can send the candidate to the company career page, or to an application for the job. The TAP 160 also provides the employer 130 the opportunity to mark Candidates as “Hired” in the TAP 160. If a Candidate applies for a job, and is noted in the “Application” section, and is confirmed to be an applicant in the company's ATS and is hired for the job, the employer 130 can mark them as “Hired”, which will be tracked in a company's Compliance Report.

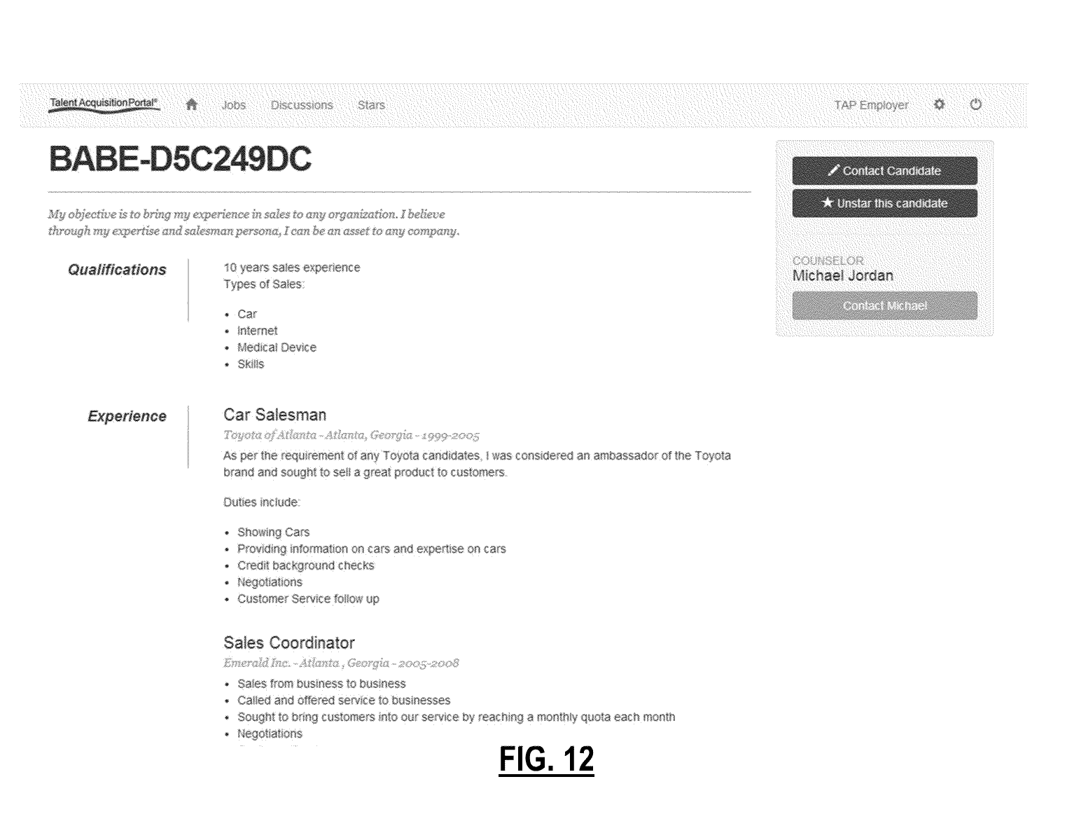

By clicking “View Candidates” below the individual job metrics on the job page posted by the employer 130, the employer 130 can now have access to an active list of candidates. This is illustrated, for example, in FIG. 11. Notice, the employer 130 is matched up to candidates initially based on the category of job they post, and the location of the job. For example, the job on this screen shot shows this job to be in Denver, Colo. in Accounting. The employer 130 can now click on candidate and view their resume, such as, e.g., illustrated in FIG. 12. Note, since the individuals 150 are candidates at the stage, so they are not uniquely identified (e.g., only first names are shown).

The employer method 400 includes the employer 130 using a search bar to search for different criteria in resumes and subsequently save search (step 411). The employer method 400 includes performing two-tiered searches by the employer 130 (step 412). The two-tiered searches include a first non-discriminatory step which lists all candidates in an identified category (e.g., accounting, sales, HR, marketing, etc.) within a given location (e.g., by city, within a fixed limit from a zip code, etc.). This non-discriminatory step utilizes matching between information in the job post by the employer 130 and information in each resume of the individuals 150. This matching is non-discriminatory. In a second step, the employer 130 can perform semantic searches to narrow the candidates, e.g., keyword searching—“bachelor of arts”, “certified”, etc. The searches can be saved by the TAP 160 for compliance tracking in the event of an audit.

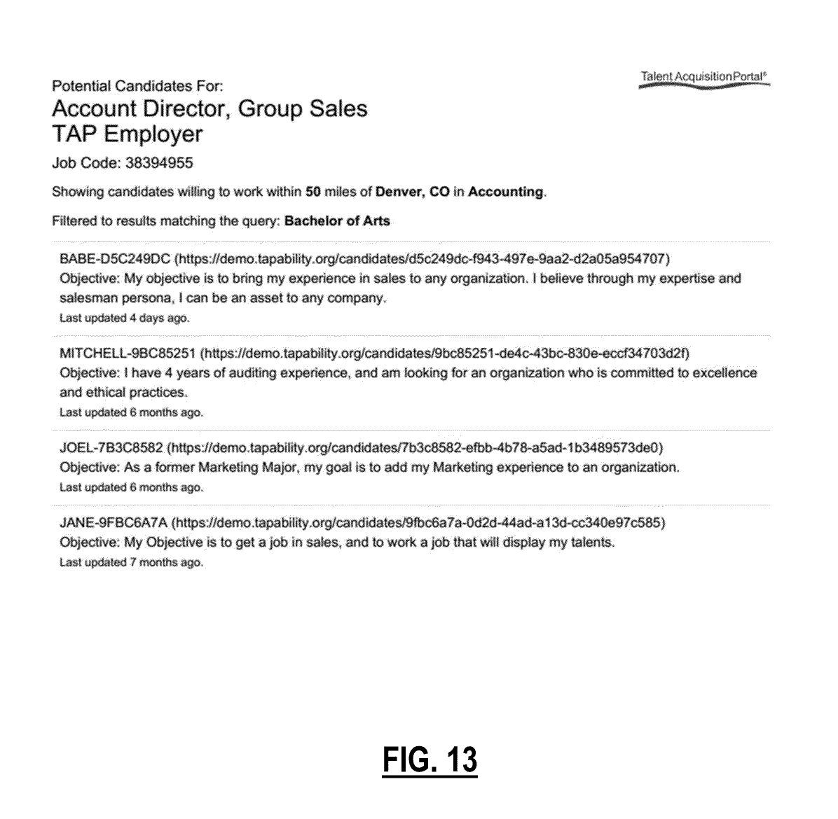

FIG. 13 is a list of candidates for a job posting subsequent to the non-discriminatory step. After the employer 130 is initially provided a list of candidates, based only on Category and Location, for example, they can type any criteria they are looking for in the search box to narrow down the list of candidates. For example, in the screenshot provided, this employer typed in Bachelor of Arts. Employers can search many different criteria by adding “And” or a space into the search bar, for example, Bachelor of Arts and 10 years' experience. This process will further narrow down the search. The employer 130 can “Save Search” to generate a PDF of the criteria that was just searched. This PDF is provided in a screen shot above. At any time by selecting “View All Saved Searches” the employer 130 can get access to every “Search” they have saved. The TAP 130 will keep it stored for the employer 130. The reports that can be generated provide: Job name, Employer name, Internal Job Code # (For recruiters), Category and Location of job, phrase that was searched, and a list of candidates who came up with what was searched.

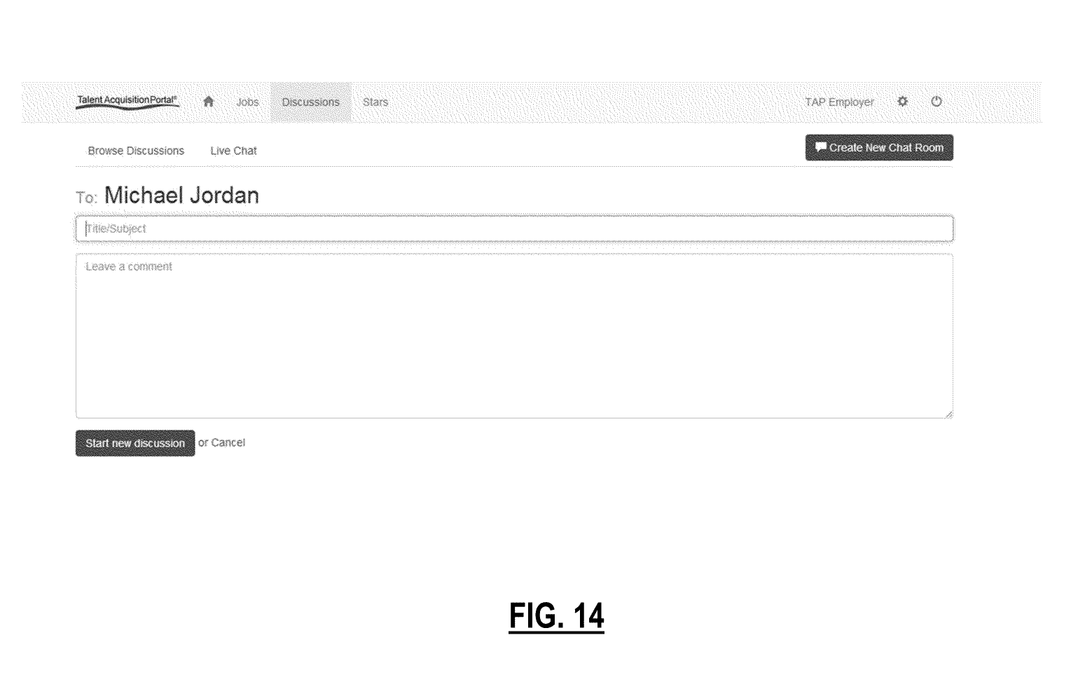

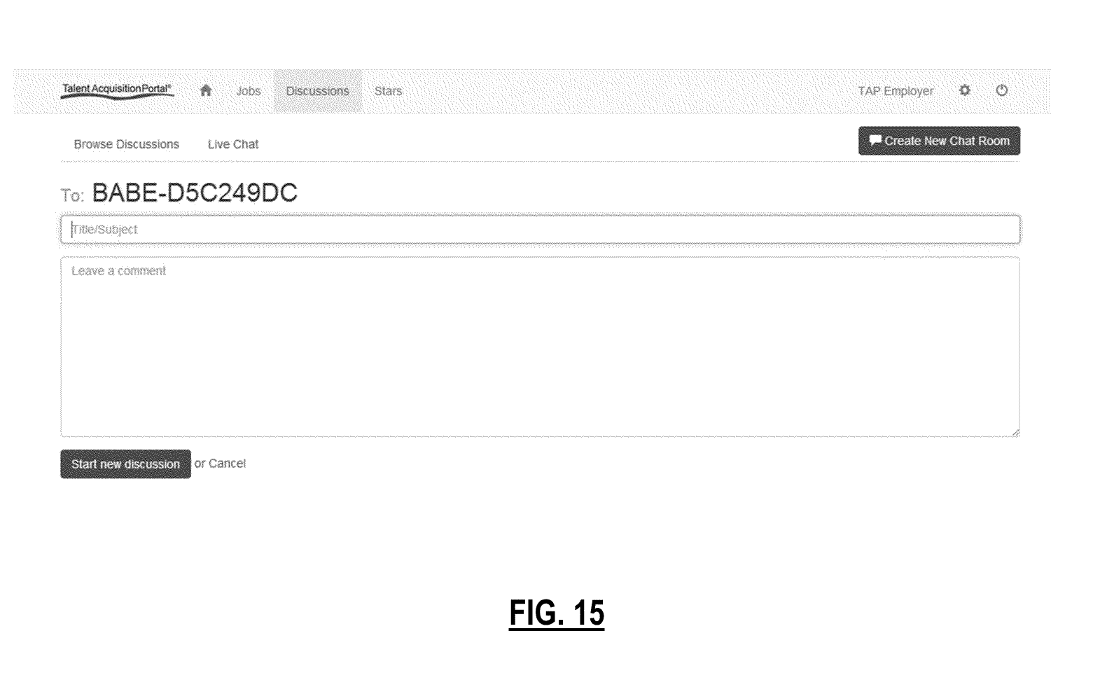

The employer method 400 can include the employer 130 communicating with the counselors 140 and/or the candidates 150 in a so-called triangulated communication structure (step 414). For example, in FIG. 14, by clicking “Contact Counselor”, the employer 130 can open up a discussion with a VR Counselor or Staff in regards to their candidate. The employer 130 can also “Contact Counselors” to ask questions related to support of a candidate, or anything that may be related to hiring and retaining an individual with a disability. In FIG. 15, the employers can also directly contact candidates. If the employer 130 feels a candidate may be a good fit for one of their positions, they can send them a message, encouraging them to apply for one of their jobs.

The triangulated communication structure is between the employers 130, the counselors 140, and the individuals 150. The triangulated communication structure includes messaging rules on who gets a copy of each message based on who is the sender. This is a feature of the TAP 160 given the fact that this is a not a one-to-one system.

| Message Sender | Designated Message Recipient | Copied sent to |
|---|---|---|
| Employer | Counselor | None |
| Employer | Individual | Associated Counselor |
| Counselor | Employer | None |
| Counselor | Individual | None |
| Individual | Employer | Associated Counselor |
| Individual | Counselor | None |

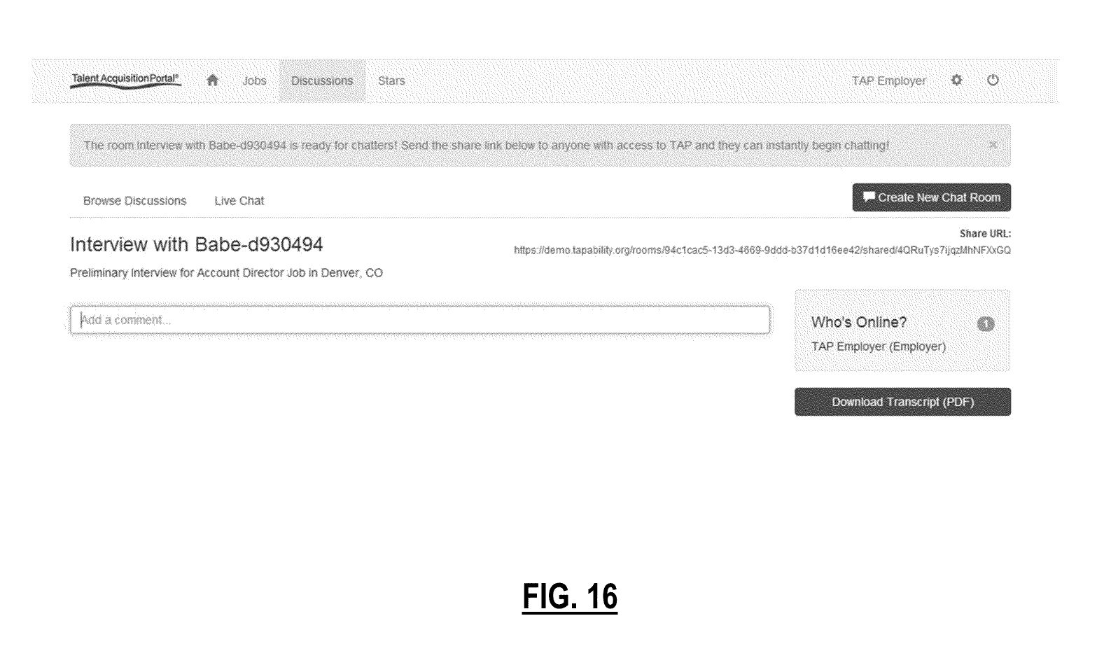

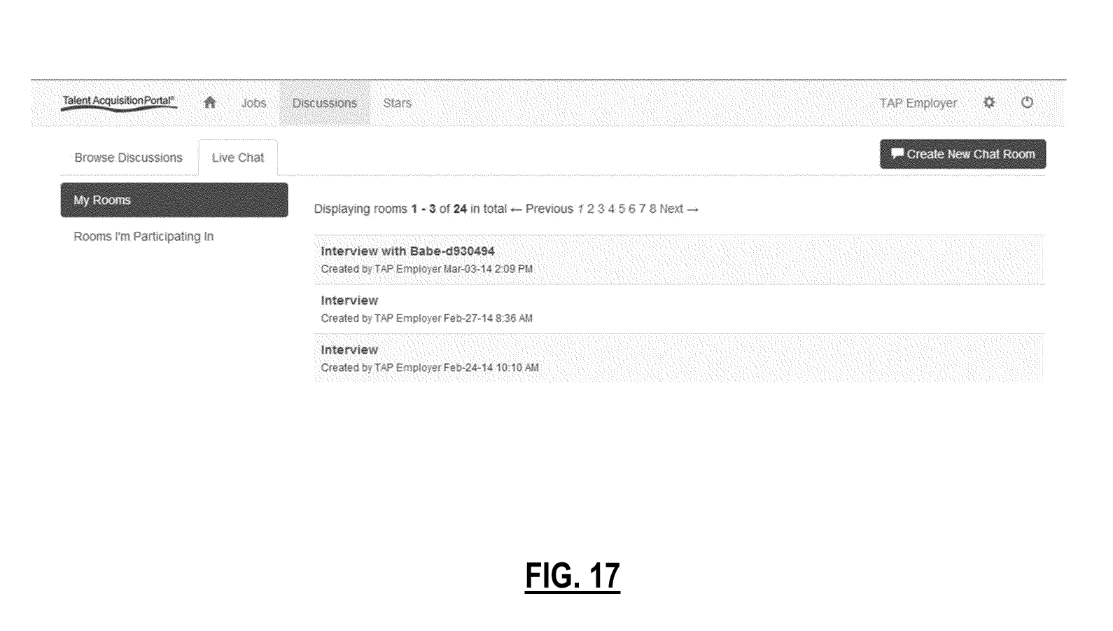

The employer method 400 can include discussions/job fairs/etc. (step 416). The employer 130, through the triangulated communication structure, can invite a candidate to join them in a “Live Chat” which can be used for an “Interview”. The “Live Chat” functionality can also be used for “Online Job Fairs”. FIG. 16 is an exemplary screen shot of a live chat. By creating a “Live Chat” or clicking “Create New Chat Room”, the employer 130 can title the room and give a topic for discussion. Once the room is created, the employer 130 employer can send the “Share URL” link to a candidate or multiple candidates for an interview. Anyone who is a member of the TAP 160 community that has this link can join this “Live Chat”. Every “Live Chat” or “Message” will be stored in the “Discussions” tab located in the Navigation Bar (e.g., as shown in FIG. 17). At any time, an employer can re-enter a discussion, and for “Live Chats” can print out a “PDF transcript” of any dialogue they have had on the TAP 160.

The employer method 400 can include tracking hired candidates (step 418). Again, the TAP 160 also provides the employer 130 the opportunity to mark Candidates as “Hired” in the TAP 160. If a Candidate applies for a job, and is noted in the “Application” section, and is confirmed to be an applicant in the company's ATS and is hired for the job, an employer can mark them as “Hired”, which will be tracked in a company's Compliance Report.

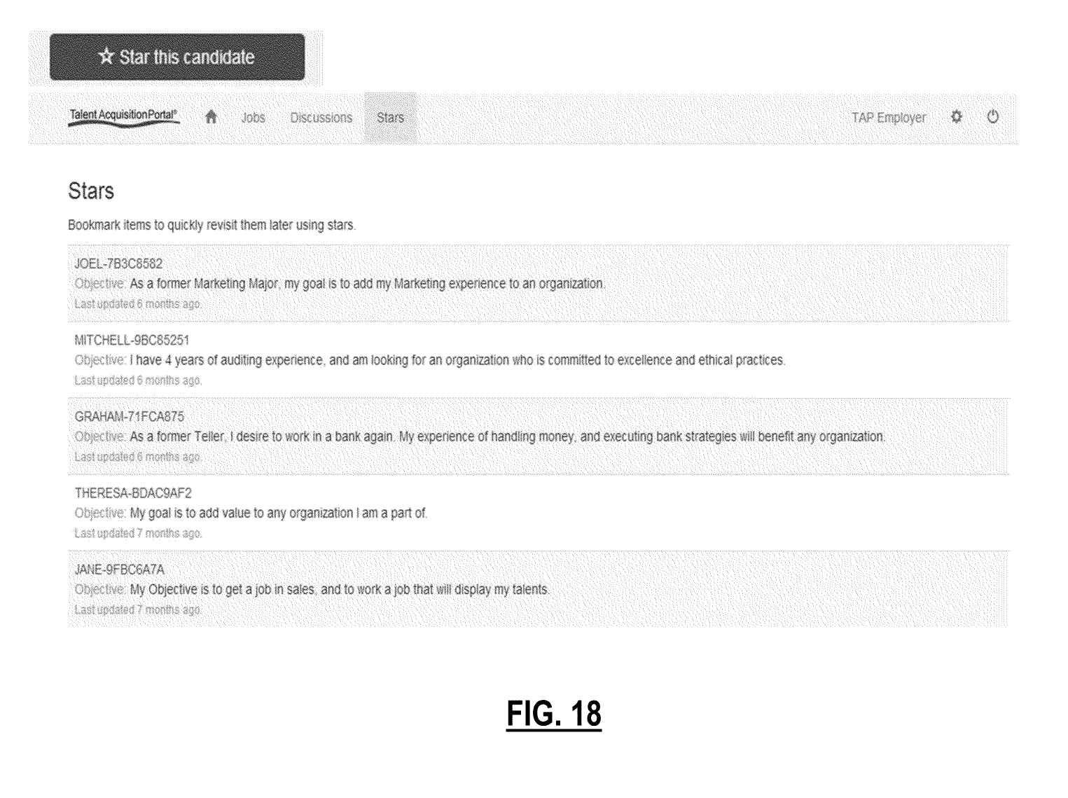

FIG. 18 illustrates an exemplary screen shot for the employer 130 to “star” candidates. “Stars”, a bookmarking system allows the employer 130 to search through candidate resumes, and “Star” or bookmark the resume to access it at a later time. This allows the employer 130 to be able to store resumes of candidates, if they want to follow up with them at a later time, or if they have sent them a message, and want to keep the resume on file temporarily.

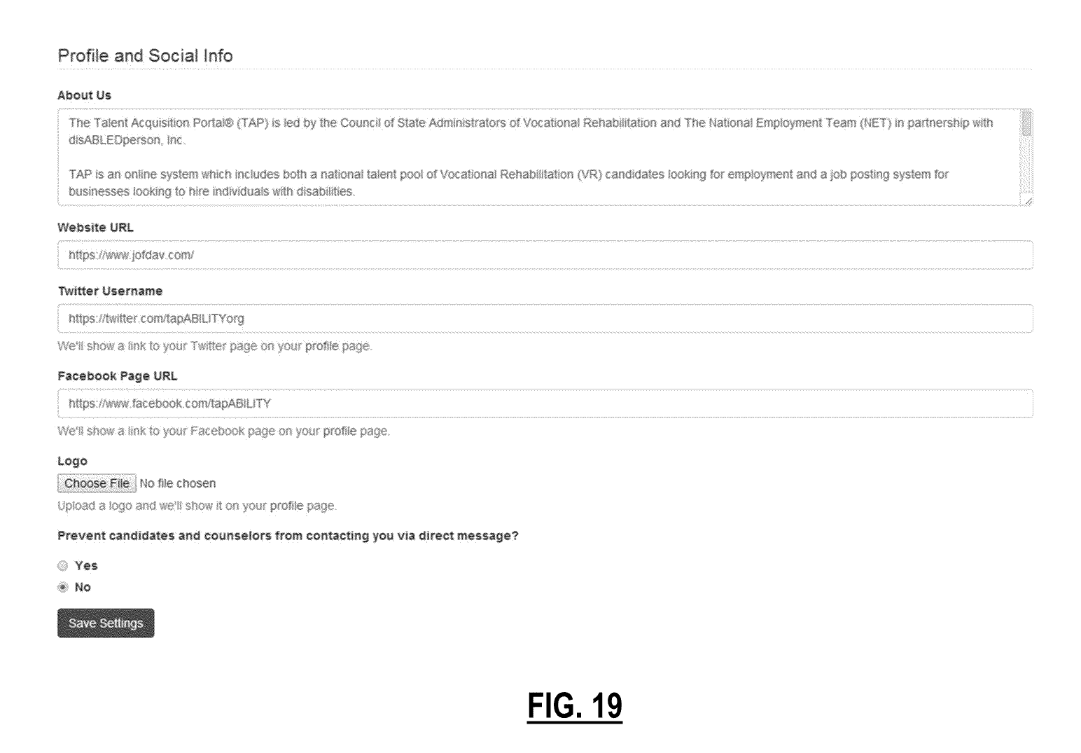

FIG. 19 is a profile screen shot for the employer 130. The employer 130 has their “Account Settings” where they can fill out information about their organization. Whenever a Candidate, or VR Counselor or Staff selects the employer's name, they will be taken to the Company Career Page of the employer 130 in the TAP 160. Here, every job posted by the employer 130 will appear. The employer 130 can also designate their Company's Website, Twitter, and Facebook Account. The employer 130 can also select a logo that they would like to be used on the TAP. The employer 130 also has the unique opportunity to “Prevent candidates and counselors from contacting you via direct message” on each Company Career Page in TAP, there will be a “Message” that allows the counselor to contact the employer 130 directly, if you want to prevent this, simply click “Yes”. By clicking “Yes” the employer 130 will still be able to contact VR, but VR will not be able to initiate contact with an employer.

### Counselor Functionality in the TAP

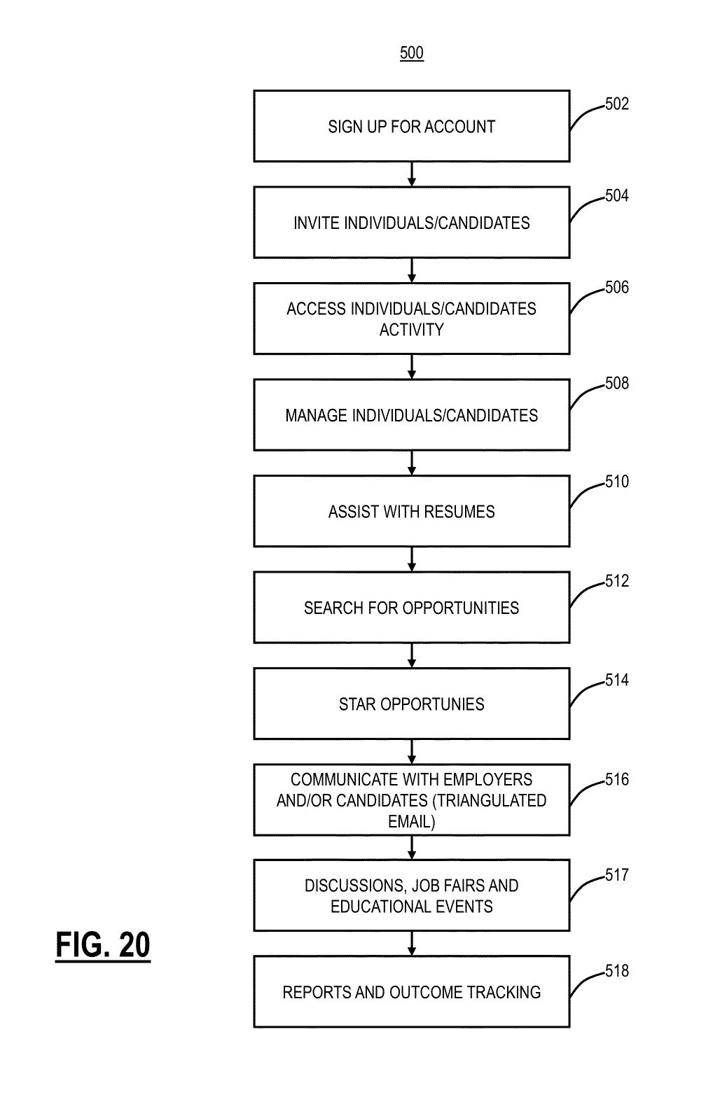

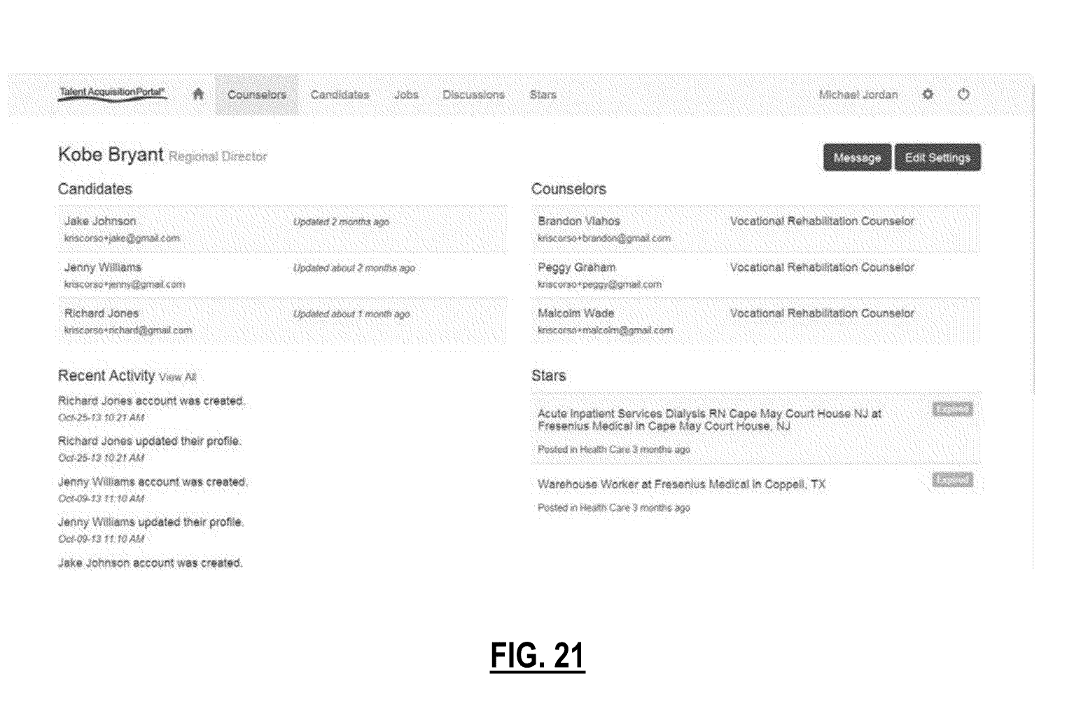

Referring to FIGS. 20-25, in an exemplary embodiment, a flowchart (FIG. 20) illustrates a counselor method 500 for functionality associated with the TAP 160 and associated screen shots (FIGS. 21-25). The counselor method 500 contemplates operation by the counselors 140 on the TAP 160 in the system 100. While the various steps illustrated in the counselor method 500 are illustrated in sequence, the steps contemplate any sequence, or omission of some of the steps. The counselor method 500 includes the counselor 140 signing up for an account with the TAP 160 (step 502). Note, since the TAP 160 is a closed system, the counselor 140 (which can be any qualifying VR counselor or staff) have to be invited to join. Here, the TAP 160 can be in a hierarchy form meaning that a counselor having a supervisory role can invite other counselors in whom they can supervise and determine their role upon joining (e.g., which candidates they are assigned to). The counselor 140 joins the TAP 160 and is assigned, by the supervising counselor, a set of the individuals 140.

The process of inviting a counselor 140 to the TAP 160 can be done by clicking “Counselors” in a Navigation Bar. Once clicking “Counselors”, the user will see a list of Counselors (If they have already been added) and can click “Invite a Counselor” on the right hand side to begin the process of inviting another counselor 140 to the TAP 160. After clicking “Invite a Counselor”, provide the information requested by the portal, and a valid email address. The TAP 160 will always assume that the counselor 140 inviting another counselor 140 into the TAP 160 is the supervising Counselor or “Parent Counselor”. If a “Parent Counselor” wants to invite a counselor 140 to the TAP 160 and assign them to the supervision of another supervising counselor or “Parent Counselor”, they can by clicking the drop down menu under “Parent Counselor”, and assigning them to another supervising or “Parent Counselor”. “Parent Counselors” can only assign a counselor 140 to another counselor 140 under their supervision.

If you want a counselor 140 to have the ability to view every candidate and counselor 140 in a respective State or Agency, you must not assign them to a “Parent Counselor” instead you must assign them as “Top-Level Counselor (no parent)”. Designating a counselor 140 a top-level counselor can only be done by the State Director or NET point of contact. Only by those who are “Top-Level Counselors”. The TAP 160 can allow preventing a counselor 140 from inviting other counselors 140. The last question the TAP 160 will ask is if you want to “Prevent this counselor from creating/inviting other counselors.” The TAP 160 will assume you do not want to prevent the counselor 140 you are inviting. However, if a counselor 140 does not supervise other counselors 140, simply click “Yes”. This will disable the counselor 140 ability to invite other counselors to the TAP 160. At any time a “Parent Counselor” can change this feature; either enabling a counselor 140 they supervise to have the ability to “Invite” other counselors 140, or disabling it.

The counselor method 500 includes the counselor 130 inviting individuals/candidates to join the TAP 160 (step 504). Since the TAP 160 is a closed system, the individuals 150 can only join based on invitation of the counselor 140. Specifically, the counselor 140 can invite those individuals 150 which are assigned to the counselor 140. When the counselor 140 invites a candidate, the TAP 160 will automatically assume that the counselor 140 inviting the candidate is the candidate's supervising or managing counselor. A candidate at any time can contact their counselor and the TAP 160 will provide the candidate easy access to do so. Note, the counselor 140 can also invite a candidate but assign them to another counselor. No VR candidate can ever be “Orphaned” in the TAP 160. If at any time a candidate's counselor 140 is no longer available, the candidate must be re-assigned to another counselor 140.

The invitation process can include the counselor 140 providing an email contact for a candidate, and the TAP 160 providing an invitation email with instructions for the candidate to join the TAP 160, e.g., a URL link, etc. Again, the TAP 160 assumes the inviting counselor 140 is assigned to the candidate, but this can be manually adjusted during the invitation process such as in the case where a staff member is inviting candidates for several counselors.

Next, the counselor method 500 includes the counselor 140 accessing individuals/candidate's activities (step 506). Upon signing into the TAP 160, the counselor 140 is presenting a home page (e.g., FIG. 21) which has a section that says “Your Candidates.” This allows the counselor to see an initial listing of candidates and the ones who have recently used the TAP 160. There can also be a link or button to see all of the candidates. Note, again in the hierarchy form, parent counselors can see all of the candidates associated with all of the counselors underneath them. For example, an agency director will be able to view every candidate in their agency, a regional director will be able to view every candidate in their regional agency, an office director will be able to view every candidate in their office, etc.

The home page also provides a section for detailing “Recent Activity.” Recent Activity includes anything done within the TAP 160 that is noteworthy, and anytime the counselor's 140 candidates do anything in the TAP 160 noteworthy including: updating their profile, “Starring” jobs, applying for a job, etc. Recent Activity for a specific candidate is available on their “Candidate Information Page” under “View Activity Log”.

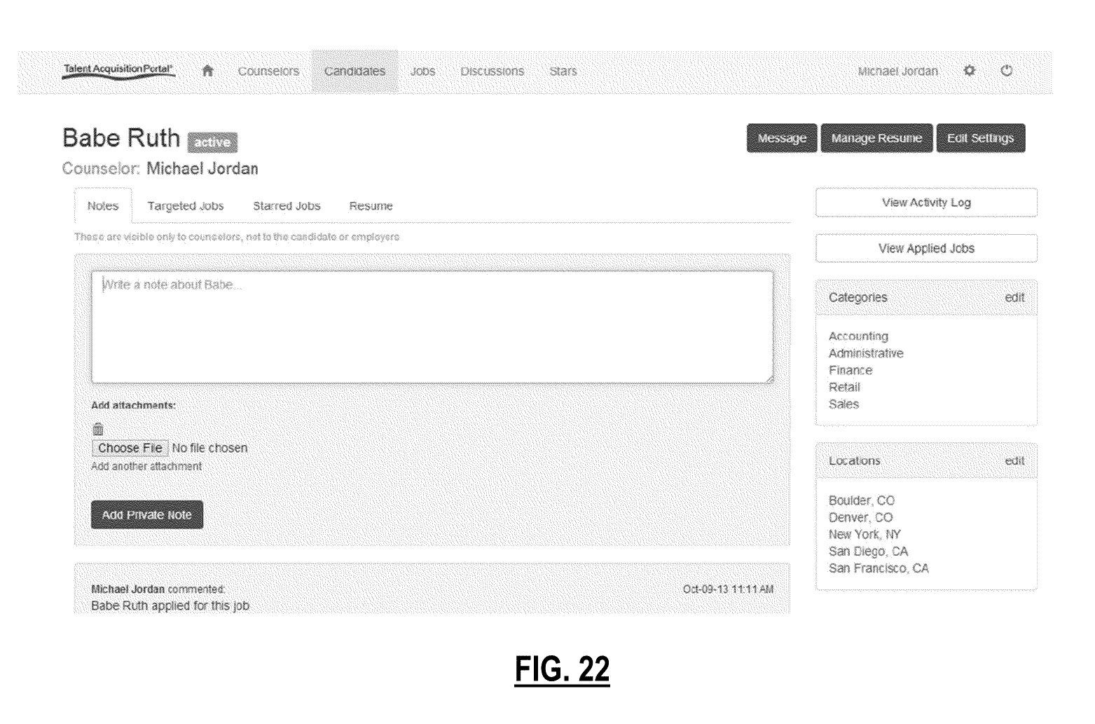

The counselor method 500 includes the counselor 140 managing their individuals/candidates (step 508). Here, the counselor 140 can access an individual candidate by clicking or selecting that candidate to bring up that individual's page (FIG. 22). Each counselor 140 has the ability to write notes about the individual candidate and store them on the individual's page. Only the counselor 140 can see the notes written about the candidate. “Parent Counselors” and any counselor who may be re-assigned this candidate will be able to see these notes. The notes are private to only the counselor 140 who has access to the specific candidate. Notes can be used to store updates and progress about candidates. Documents can be uploaded to a candidates “Notes” section. No Candidate can see these notes, only for the counselors 140.

For “Parent Counselors”, by clicking “Counselors” in the Navigation Bar (FIG. 22), a counselor 140 will have access to a list of counselors 140 whom they supervise or directly supervise. Those who supervise more counselors 140 will have more individuals on their list. For example, a State Director will be able to see every counselor 140 in their State, a Regional Director will be able to see everyone in their region below their supervision, but no one above them, an Office Director will be able to see any they supervise in their office, but no one above them, etc. A counselor 140 who does not supervise any counselors will not have access to this page.

The counselor method 500 includes assisting candidates with resumes (step 510). The resume of a specific candidate is accessed by selecting a Candidate from the counselor's 140 “Candidate List”. The counselor 140 has exactly the same access to edit a specific candidate's resume as the candidate does. Any edits the counselor 140 does to a candidate's resume, will be reflected as such to the candidate as well as employers/business. The counselor 140 can encourage their candidate to input their own resumes. The counselor 140 will be notified in the “Recent Activity” section when they initially sign into the TAP 160 anytime their candidates update their resume or have any activity on the system (Click “View Activity” on Candidate Information Page). Also, the counselor 140 can manage and fix anything a candidate inputs into their resume.

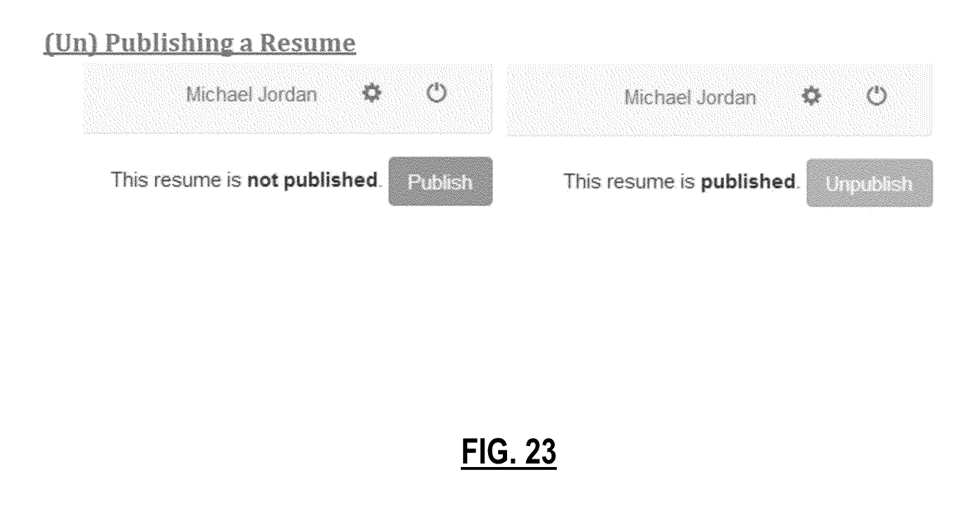

A candidate's resume will never be searchable to employers, or added to the job match system until it is published. A resume can be saved and updated, but until it is published, it will not be added to the matching system of the TAP 160. If a candidate or counselor 140 would like to update the resume without it being seen in the matching system, they can unpublish it (see FIG. 23), and then publish it once it is finished. Both the counselor 140 and candidates can download a candidate/consumer resume in PDF form. The TAP 160 can include a resume builder tool to help the counselor 140 and the candidate create a resume. The resume section will allow a candidate/consumer to solicit employers with their skills and education that will be searched by employers once published, but can also be used as a resume builder and be used to generate a resume. No personal contact information is made available to employers/business unless the candidate chooses to provide it to them. When an employer searches a candidate's resume, only the first name of the candidate will be displayed. Employers/Business will see a list of candidates in the following format: “JANE-3094950”. Any contact information will always stay private unless disclosed by the candidate/consumer. The only exception to this is if a candidate/consumer decides to respond to an employer's inquiry and disclose their contact information on their own or apply for a job, their full name will then be presented to the employer. Any other contact or personal information will stay private and is up to the discretion of the candidate/consumer to disclose to the employer.

As part of the resume, a category (e.g., accounting, sales, etc.) and location are input for the two-tiered searching, i.e., for the non-discriminatory step. The counselor 140 should ensure these are properly filled out to get the candidate in front of the right employers. The counselor method 500 includes performing searches for jobs for candidates. Here, the TAP 160 can provide a job list showing the most recent jobs added. The listing can include a job title, employer, and location. The counselor 140 can search for jobs for candidates using employer, location, category, and/or semantic searches. That is, the counselor 140 does not have the same limitations as the employer 130 with respect to the two-tiered searching.

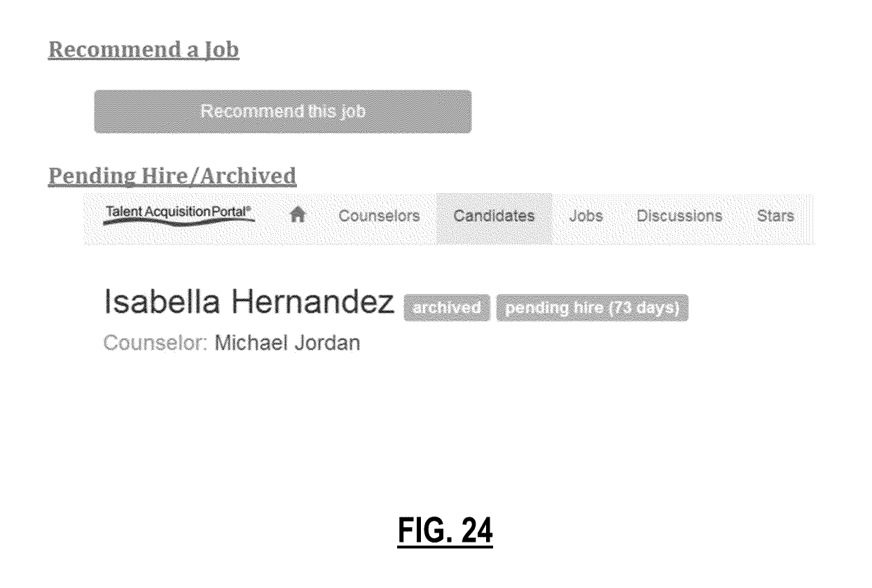

If the counselor 140 finds a particular job of interest possibly to a candidate, the counselor 140 can “star” for future reference such as to notify or recommend the candidate (step 514). If the counselor 140 likes the job after reviewing it, and has a specific candidate/consumer in mind; there is an option to “Recommend this job”. Simply click “Recommend this Job”, and select a candidate or multiple candidates to recommend the job to. This is shown, for example, in FIG. 24. “Stars” is a bookmarking system within the TAP 160 that allows users to bookmark or “Star” jobs to easily access them at a later time. Both candidates and counselors 140 can star jobs they are searching. “Star” jobs to locate them again quickly, and “Star” jobs to “Recommend” them to candidates at a later time. Candidates/Consumers will also receive emails notifying them anytime their counselor 140 “Recommends a job” for them.

The counselor method 500 includes discussions/communication with the employers and candidate (via the triangulated communication structure) (step 516). Here, the triangulated communication structure is the same as described herein. The TAP 160 will alert the individual who received the message through email that a “Discussion” has begun between themselves, and another individual. By clicking to respond to the “Message” and begin a “Discussion” through email, the individual will be brought back into the TAP 160 to respond. Every “Discussion” or “Chat” will always be kept on record, so that you can go back to it at a later time if needed. The counselor method also includes the counselor 140 participating in discussions, job fairs, educational events, etc. with the individuals 150 and/or the employers 130 (step 517).

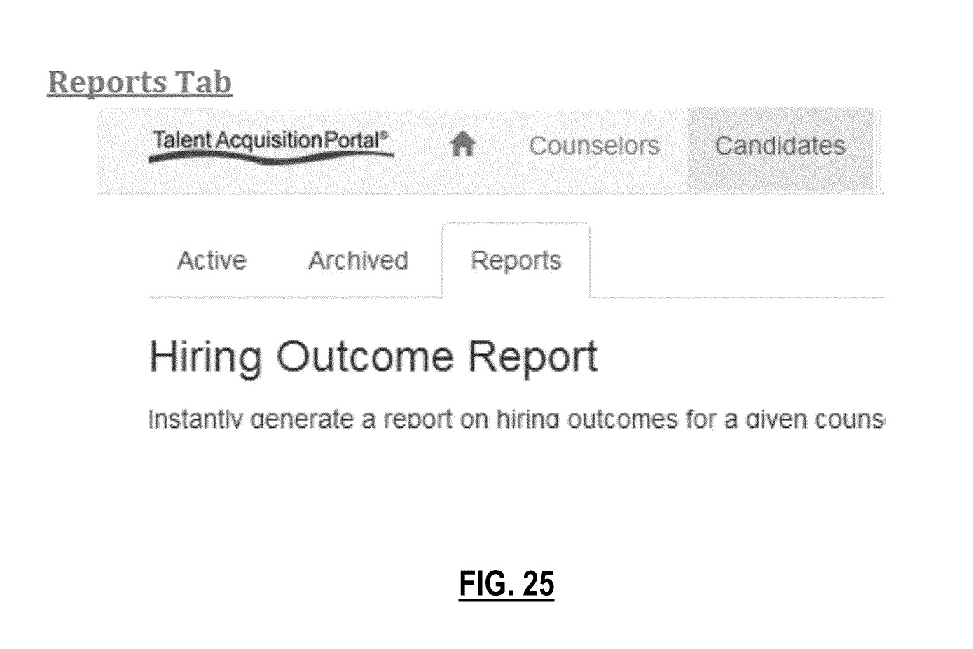

The counselor method 500 includes reports and outcome tracking (step 518). Each counselor 140 has the opportunity to view jobs that individual candidates have applied for, and from this list also mark their individual candidate as hired for a specific job. The counselor 140 can mark candidates as hired for jobs specifically in the TAP 160, or even mark them as hired for jobs outside of the jobs listed in the TAP 160. An outcome report is available for each counselor 140 to generate (FIG. 25).

In order to mark a candidate as hired, a counselor 140 must first go to the specific candidate's “Candidate Information Page”. Once on the “Candidate Information Page”, a counselor 140 can click on “View Applied Jobs” for the specific candidate. A list of every job in the TAP 160 that the candidate has applied for will show up in this section. Within the “View Applied Jobs” listing, each job a candidate has applied for will be listed. Next to each job, there will be an opportunity to click “Mark Hired for this Job”. However, once a candidate is marked hired, their resume will no longer be active in the TAP matching system unless the hire is “revoked”. Once a candidate is marked hired, a 90 day “Pending Hire” clock will begin.

Every job a candidate has applied for within the TAP 160 will have a button next to the job that says “Mark Hired for this Job”. By clicking “Mark Hired for this Job” a candidate will now begin the “Pending Hire” Process. When a candidate is marked as hire and is in the “Pending Hire Process” their resume will not be visible to employers. Once a candidate is “Marked Hire for this Job”, the candidate will be in a “Pending Hire” process that lasts 90 days. The resume of a candidate will not be visible to employers during this process, since they are “Pending Hire”. A report will include a tally of pending hires for an individual, or for the agency, but will only include names of candidates who have passed the 90 day period. No candidate will appear as a hire on a report unless they reach the end of the 90 day process that will automatically begin upon clicking “Mark Hire for this Job”.

When a candidate is marked as hired, and begins the “Pending Hire” process, mark them as “Archived” to keep them organized. Next to the candidates name on their “Candidate Information Page” it will say the status of the candidate “Active” or “Archived” and if they are “Pending Hire”. Click on the “Active” button and it will allow you to “Archive” the candidate, or go to “Edit Settings” on the “Candidate Information Page” to “Archive”.

To “Revoke” a hire, go to the “Candidate Information Page”, and where it says “Pending Hire” next to the candidates “Active/Archived” status, click on “Pending Hire”. After clicking “Pending Hire” a window will appear that shows who hired the candidate, the name of the position, and the date they were marked hired in the TAP 160 as well as the date the 90 day “Pending Hire” process will be over and the hire will be “Verified”. On this window, there will be the option to “Revoke” this hire. “Revoking” a hire after the 90 days will result in the candidate name no longer being marked as “Hired” on your Outcome report for any given month. If a candidate is found not to have remained hired for 90 days, a counselor 140 may “revoke” the hire, and make the candidate “Active” in the system again. Revoking should only be done for candidates who have either lost their job, or never received their job within the 90 day “Pending Hire” process.

By “Revoking” a hire, it is the same as saying “The hire never took place” or “The hire did not meet the 90 day “Pending Hire” requirement”. Any “Pending Hires” that are “Revoked” within the 90 day “Pending Hire” process will mean that a candidate's resume is back in the TAP Matching system, and that their resume is again visible to employers once they are “Un-archived”. A counselor 140 should never revoke a candidate who has passed the 90 day “Pending Hire” process, because they are then counted as a hire, unless the hire is never “Closed”. By revoking a candidate after the 90 day “Pending Hire” process, a candidate will appear as if they were never hired.

If a candidate is “Revoked” before the completion of the 90 day “Pending Hire” process, and a counselor 140 wants to record that somewhere, note that in the candidate's “Notes” section located on the “Candidate Information Page”. Once a candidate is “Verified” as “Hired” they will no longer be able to have their resumes searched by employers. Candidates may still search jobs, and apply for jobs but their resume will never be visible to an employer. If a candidate is confirmed or “Verified” as hired after the 90 day “Pending Hire” process and after a year decides he/she wants to rejoin the TAP 160 due to any reason, the counselor 140 will need to re-invite that candidate and start over.

The ultimate goal of the TAP 160 is to get a candidate hired, so, once a candidate is “Hired” officially, in order for them to come back to the portal, they need a new invitation and must be re-invited. Note, the candidate may need to use a new email address to be invited a second time. Employers have the same opportunities to mark candidates as hired through the employer side of the portal. Anytime an employer marks a candidate as hired, the 90 day “Pending Hire” process will begin for a candidate on the VR side of the portal that a counselor 140 will be able to see. Anytime a counselor 140 marks a candidate as hired, the employer will have the candidate as hired for the specific position on their report. Each counselor 140 has the opportunity to mark candidates they manage in the TAP 160 who were hired by an employer outside of TAP as hired. By clicking “Hired Externally” on the “Candidate Information Page” below “View Applied Jobs”.

Reports can be accessed by first clicking “Candidates” in the Navigation Bar, and then clicking the tab labeled “Reports” next to “Active” and “Archived” in the TAP 160. On the Hiring Outcome Report page, one can generate a report oneself, or any other counselor that one supervises. Reports include the number of pending hires per month, as well as any “Verified” hires, or candidates who were able to pass the “Pending Hire” process. Reports are generated in PDF form, and can be generated at any time.

### Individual Functionality in the TAP

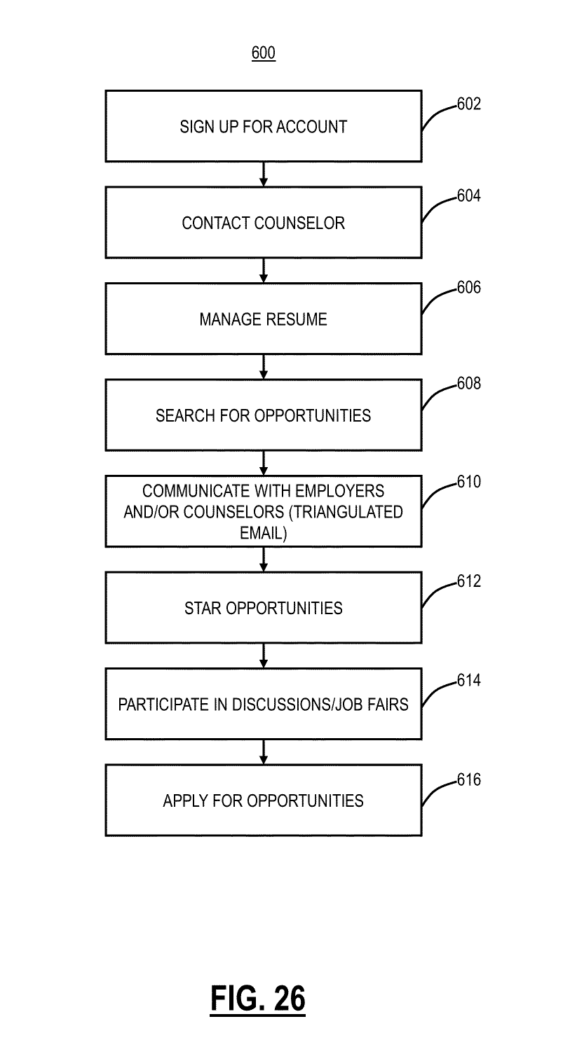

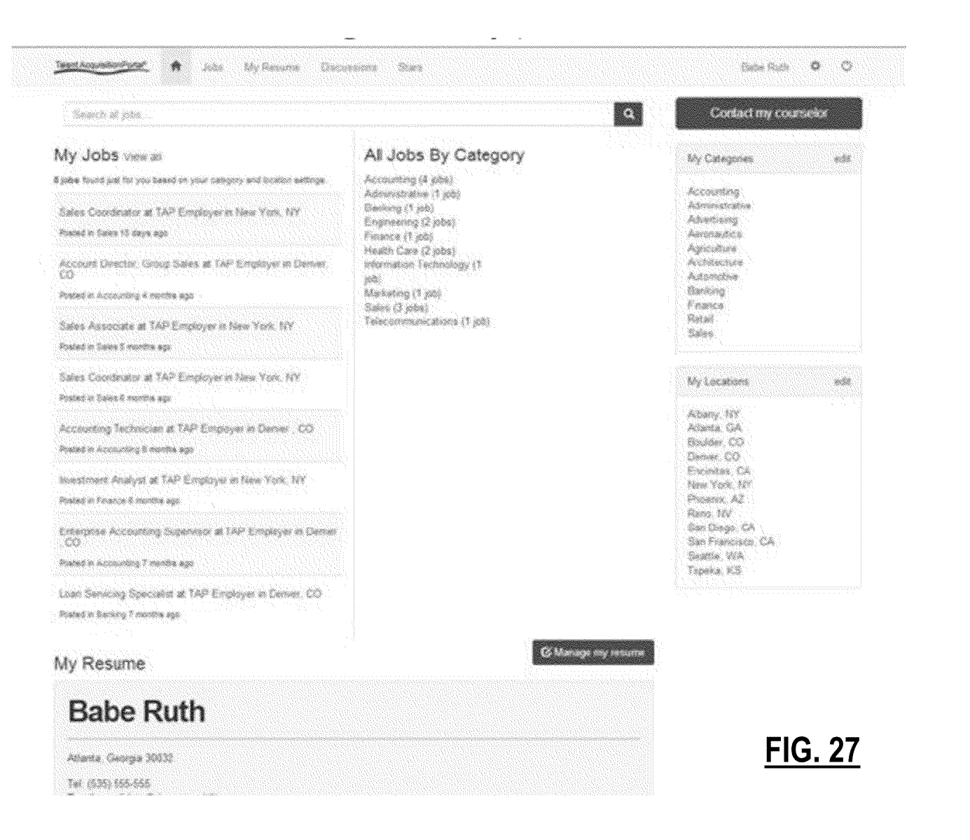

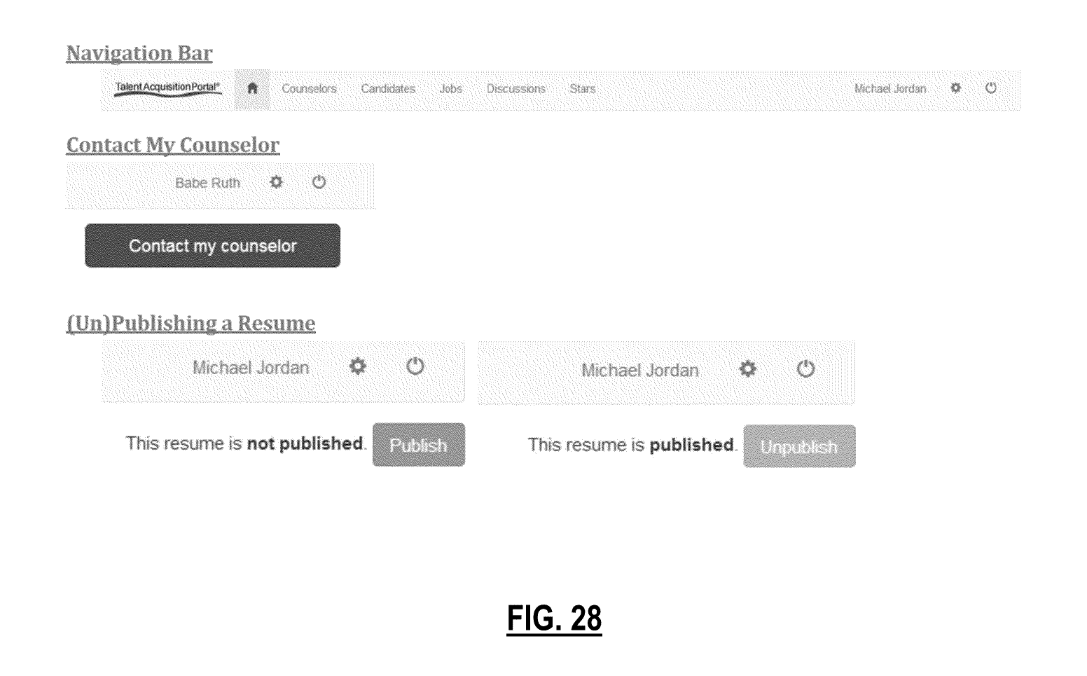

Referring to FIGS. 26-29, in an exemplary embodiment, a flowchart (FIG. 26) illustrates a candidate method 600 for functionality associated with the TAP 160 and associated screen shots (FIGS. 27-29). The candidate method 600 contemplates operation by the individuals 150 on the TAP 160 in the system 100. While the various steps illustrated in the candidate method 600 are illustrated in sequence, the steps contemplate any sequence, or omission of some of the steps. The candidate method 600 includes the candidate signing up for an account with the TAP 160 (step 602). Again, the TAP 160 is a closed system, so the candidate has to be invited by a counselor, and signs up based on this invitation, e.g., a URL link in an email.

After signing into the TAP, the candidate is shown a home page (FIG. 27) where various functions can occur. This home screen can include a “My Jobs” section where the candidate is prompted to edit their category and location. The TAP 160 will encourage this for first time users. Next, the candidate method 600 includes the candidate contacting their counselor (step 604) and/or managing their resume (step 606). Each Candidate has the opportunity to “Contact My Counselor” which is located at the top right of the screen upon login to the TAP 160. By clicking “Contact My Counselor”, the candidate will open up a message that will be sent directly to his/her Counselor. A candidate will always be synced up to his/her VR Counselor, and be able to communicate with them directly at any time. The message will state who the candidate is sending the message to, and will also provide a “Title/Subject” line as well as an area to write a message. The resume can be input directly on the TAP 160 and/or via uploading a file. The candidate can choose to publish/unpublish their resume. Also, the candidate can work on the resume alone or with help of the counselor. The description with respect to the resume in the counselor method 500 also applies to the candidate method 600.

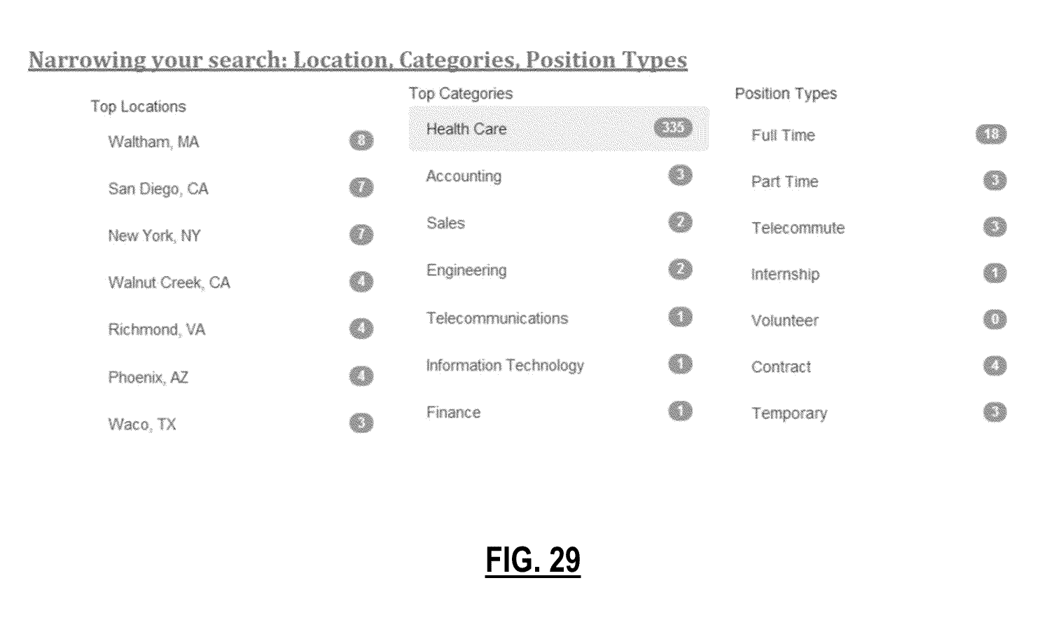

The candidate method 600 allows the candidate to search for opportunities (step 608). The job search here can be similar as described in the counselor method 500, i.e., the candidate is not forced to abide by the two-tiered search structure. See FIG. 29, for example. The candidate can communicate with employers and/or counselors using the triangulated communication structure (step 610). The triangulated communication structure is the same as discussed herein with respect to the employer method 400 and the counselor method 500. The candidate can star opportunities similarly to how the counselor stars opportunities (step 612). The candidate can participate in discussions, job fairs, online interviews, etc. (step 614). Finally, the candidate can apply for opportunities through the TAB 160 or be directed to an employer's external system for applying (step 616).

Specifically, the TAP 160 can operate on the server 110 and include an employer function to implement the various aspects of the employer method 300, a counselor function to implement the various aspects of the counselor method 400, and a candidate function to implement the candidate method 500. Note, while these are described separately, this is for illustration purposes. While logically described separate, the various functions for the employer method 300, the counselor method 400, and the candidate method 500 can be part of an integrated program realizing the TAP 160. Thus, it will be appreciated that some exemplary embodiments described herein may include one or more generic or specialized processors (“one or more processors”) such as microprocessors, digital signal processors, customized processors, and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the aforementioned approaches may be used. Moreover, some exemplary embodiments may be implemented as a non-transitory computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer readable medium, software can include instructions executable by a processor that, in response to such execution, cause a processor or any other circuitry to perform a set of operations, steps, methods, processes, algorithms, etc.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. A talent acquisition portal, comprising:
one or more servers communicatively coupled over a network to one or more employers, one or more counselors, and one or more candidates, wherein the one or more servers are collectively configured to implement:
an employer function enabling the one or more employers to post opportunities and find candidates based on a two-tiered search structure;
a counselor function enabling the one or more counselors to invite other counselors to join the talent acquisition portal, interact with assigned candidates of the one or more candidates, and assist the assigned candidates with finding an opportunity;
a candidate function enabling the one or more candidates to sign up responsive to an invite from one of the one or more counselors, develop a resume, and search and apply for one of the opportunities; and
a triangulated communication structure between the one or more employers, the one or more counselors, and/or the one or more candidates.

2. The talent acquisition portal of claim 1, wherein the talent acquisition portal is a closed system to the one or more counselors and the one or more candidates with the one or more counselors being invited to join from another of the one or more counselors in a hierarchy and with the one or more candidates being invited to join from one of the one or more counselors.

3. The talent acquisition portal of claim 2, wherein the one or more candidates each comprise an individual qualifying for job placement assistance through an agency.

4. The talent acquisition portal of claim 2, wherein the one or more counselors each comprise an individual identified as a counselor or staff member with an agency assigned to help the one or more candidates with job placement assistance.

5. The talent acquisition portal of claim 1, wherein the two-tiered search structure comprises a first non-discriminatory step and a second step based on semantic matching.

6. The talent acquisition portal of claim 5, wherein in the first non-discriminatory step, the two-tiered search structure provides all of the one or more candidates who match a category within a certain location.

7. The talent acquisition portal of claim 5, wherein the one or more counselors and the one or more candidates are enabled to perform searches of the opportunities posted by the one or more employers without using the two-tiered search structure.

8. The talent acquisition portal of claim 5, wherein the one or more candidates are not uniquely identified to the one or more employers until a candidate applies or discloses to an employer.

9. The talent acquisition portal of claim 1, wherein a counselor is enabled to perform a search of the opportunities posted by the one or more employers without using the two-tiered search structure for any candidate assigned to the counselor.

10. The talent acquisition portal of claim 9, wherein the counselor is configured to recommend an opportunity to any candidate assigned to the counselor.

11. The talent acquisition portal of claim 1, wherein the triangulated communication structure comprises any message sent from an employer to a candidate or from the candidate to the employer being copied to an associated counselor.

12. The talent acquisition portal of claim 1, wherein the employer function further enables compliance tracking by the one or more employers with respect to searches and hiring.

13. The talent acquisition portal of claim 1, wherein the counselor function further enables compliance tracking by the one or more counselors with respect to hiring of associated candidates and tracking a 90 day verification process to determine whether the associated candidates no longer require job searching assistance.

14. The talent acquisition portal of claim 1, wherein the counselor function further enables counselors to view all candidates under them and under counselors who are under them in a dashboard.

15. A talent acquisition system, comprising:
a network interface, a data store, and a processor, each communicatively coupled therebetween; and
memory storing instructions that, when executed, cause the processor to:
sign up a user as one of an employer, a counselor, and a candidate, wherein the counselor is signed up responsive to an invite from another counselor, and wherein the candidate is signed up response to an invite from a counselor;
receive opportunities to post from the employer;
perform a two-tiered search for the employer;
invite other counselors by the counselor;
enable the counselor to interact with assigned candidates;
enable the counselor to assist the assigned candidates with finding an opportunity;
enable the candidate to develop a resume and search and apply for the opportunities; and
coordinate a triangulated communication structure between the employer, the counselor, and/or the candidate.

16. A talent acquisition method, comprising:
signing up a user as one of an employer, a counselor, and a candidate, wherein the counselor is signed up responsive to an invite from another counselor, and wherein the candidate is signed up response to an invite from a counselor;
receiving opportunities to post from the employer;
performing a two-tiered search for the employer;
inviting other counselors by the counselor;
enabling the counselor to interact with assigned candidates;
enabling the counselor to assist the assigned candidates with finding an opportunity;
enabling the candidate to develop a resume and search and apply for the opportunities; and
coordinating a triangulated communication structure between the employer, the counselor, and/or the candidate.
